(19) United States
(12) Patent Application Publication
(10) Pub. No.: US 2026/0288785 A1
(43) Pub. Date: Sep. 24, 2026

(54) SYSTEM

(71) Applicant: SoftBank Group Corp., Tokyo (JP)

(72) Inventor: Tsubasa MARUYAMA, Tokyo (JP)

(73) Assignee: SoftBank Group Corp., Tokyo (JP)

(21) Appl. No.: 19/558,503

(22) Filed: Mar. 6, 2026

(30) Foreign Application Priority Data
Mar. 19, 2025 (JP) 2025-044522

(51) Int. Cl. G06F 16/3329; G06F 16/34; G06N 3/0475; G10L 25/30; G10L 25/63

(52) U.S. Cl. CPC G06F 16/3329; G06F 16/345; G06N 3/0475; G10L 25/30; G10L 25/63

(57) ABSTRACT

A system includes a processor that is configured to query a dictionary database for meaning information corresponding to a phrase selected by a user, transmit the acquired meaning information to a terminal of the user and cause the acquired meaning information to be displayed on a display screen of the terminal, generate a prompt sentence for instructing a generative AI model to generate a specific response based on the selected phrase, transmit the generated prompt sentence to the generative AI model, receive a response from the generative AI model, apply a character limit to the received response to adjust the received response, and transmit the adjusted response to the terminal of the user and cause the adjusted response to be displayed on the display screen.

### CROSS-REFERENCE TO RELATED APPLICATION

This application is based on and claims priority under 35 USC 119 from Japanese Patent Application No. 2025-044522 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional word explanation systems in messaging or communication environments typically rely only on static dictionary data and require the user to perform multiple operations, such as switching applications or manually copying and pasting text, in order to obtain additional, contextual information. As a result, the user cannot seamlessly obtain both dictionary-based meaning information and dynamically generated, context-aware explanations within the same user interface. Furthermore, even when generative AI models are used to provide explanations, the generated responses may be excessively long or verbose, which leads to poor readability on limited-size display screens of user terminals and degrades the user experience. Therefore, there is a need for a system that enables a user to obtain dictionary-based meaning information and AI-generated responses in an integrated manner, directly on the display screen of the user terminal, while automatically controlling the length of the AI-generated responses so that the responses remain concise and suitable for display.

### SUMMARY

In order to solve the above-described problems, a system is provided comprising a processor, wherein the processor is configured to query a dictionary database for meaning information corresponding to a phrase selected by a user, and to transmit the acquired meaning information to a terminal of the user and cause the acquired meaning information to be displayed on a display screen of the terminal. The processor is further configured to generate a prompt sentence for instructing a generative AI model to generate a specific response based on the selected phrase, to transmit the generated prompt sentence to the generative AI model, and to receive a response from the generative AI model. The processor is configured to apply a character limit to the received response to adjust the received response, and to transmit the adjusted response to the terminal of the user and cause the adjusted response to be displayed on the display screen. In one embodiment, the processor is configured to generate the prompt sentence including the selected phrase, thereby enabling the generative AI model to generate a response directly related to the phrase selected by the user. In another embodiment, the processor is configured to apply the character limit to the received response by truncating the received response to a predetermined maximum number of characters, thereby ensuring that the AI-generated response remains concise and appropriately sized for display on the user terminal.

The term “system” refers to an aggregation of hardware and software components, including at least one processor and associated memory and interfaces, that cooperatively perform the functions recited in the claims.

The term “processor” refers to any hardware component or combination of hardware components, such as a central processing unit (CPU), microprocessor, microcontroller, digital signal processor (DSP), application-specific integrated circuit (ASIC), field-programmable gate array (FPGA), or other programmable logic device, that is configured to execute instructions and perform the operations described in the claims.

The term “dictionary database” refers to any data storage or data structure that stores lexical entries, including words or phrases and associated meaning information, definitions, or explanatory text, which can be queried by the processor based on a user-selected phrase.

The term “meaning information” refers to definition text, explanatory text, or other lexical information that describes or explains the semantic content of a word or phrase stored in the dictionary database.

The term “phrase” refers to a word, multiple words, or any continuous sequence of characters that can be selected by the user from content displayed on the user terminal.

The term “user” refers to a human operator who uses the terminal, selects a phrase displayed on the terminal, and views the meaning information and responses provided by the system.

The term “terminal” refers to any user device, such as a smartphone, tablet, personal computer, or other electronic device, that includes at least a display screen and a communication function, and that is capable of sending data to and receiving data from the system.

The term “display screen” refers to any visual output interface of the terminal, including but not limited to a liquid crystal display (LCD), organic light emitting diode (OLED) display, or other display device, on which text or graphical information is presented to the user.

The term “prompt sentence” refers to a text string generated by the processor that includes an instruction or request intended for a generative AI model, and that is used to cause the generative AI model to generate a specific response related to a selected phrase.

The term “generative AI model” refers to an artificial intelligence model, such as a large language model or other machine learning model, that is configured to generate natural language text or other content in response to an input prompt.

The term “response” refers to text generated by the generative AI model based on the prompt sentence, and may include explanations, definitions, or other information related to the selected phrase.

The term “character limit” refers to a predetermined maximum number of characters or other length constraint applied by the processor to the response generated by the generative AI model in order to adjust the length of the response.

The term “adjusted response” refers to a response that has been processed by the processor to conform to the character limit, including, for example, by truncating the response to the predetermined maximum number of characters and optionally adding an indication of truncation.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

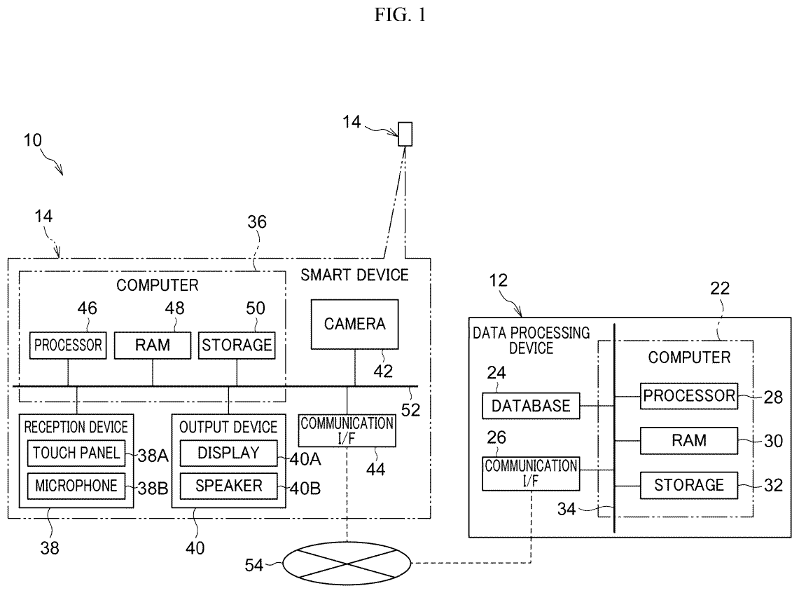

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

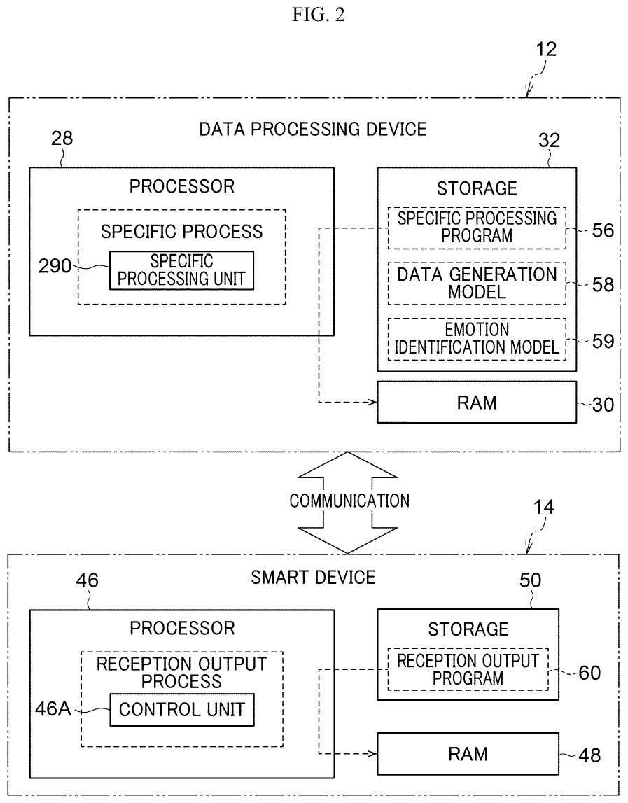

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information lookup techniques on messaging or other text-centric user interfaces require users to leave an ongoing application context, open a separate search or dictionary application, and manually input a term to be queried. This context switching increases interaction cost, introduces latency in obtaining the desired meaning information, and degrades overall usability. Moreover, when natural language generation techniques are used as a substitute for static dictionary data, the generated explanations tend to be verbose, inconsistently formatted, or poorly adapted to constrained display regions such as message bubbles, which results in information overload and visual clutter on small screens.

In many existing systems, the application merely forwards a user-selected term to a remote service and displays whatever text is returned, without coordinating dictionary-based meaning retrieval, generative AI-based explanation generation, and UI-level constraints such as character limits, layout, and association with the original text. As a consequence, the system fails to exploit the complementary strengths of structured reference data and generative AI models, and cannot reliably provide concise, context-appropriate responses at interactive speeds.

From a computer-technology perspective, there is a need for an improved processing architecture in which a server and a terminal cooperatively perform: (i) precise capture and identification of user-selected character strings within an existing display context, (ii) dual-path processing that combines dictionary lookup and generative AI model responses, (iii) automatic generation and conditioning of prompt sentences with explicit constraint information for the generative AI model, and (iv) post-processing of generated responses under strict character-length control and persistent association with unique identifiers for robust UI updates. Without such an integrated mechanism, the computing system cannot efficiently manage network, processing, and screen resources to deliver concise, high-relevance explanations tightly bound to the original on-screen content.

Accordingly, the technical problem to be solved is to improve the functioning of a computer system, including a server and a terminal, so that the system can, in response to a user's in-place selection of text on a display screen, automatically and efficiently obtain meaning information and generative explanations, enforce character-length and style constraints appropriate for limited display areas, and maintain an internal linkage structure that supports consistent re-display and adaptive optimization based on accumulated statistical information.

The specific processing by the specific processing unit 290 of the data processing device 12 in Example 1 is realized by the following means.

The present invention provides a server comprising a processor configured to receive, from a terminal operating on a user information processing apparatus, inquiry data including character string data selected by a user on a display screen; to extract the selected character string data from the received inquiry data, query a dictionary storage device for meaning information corresponding to the character string data, acquire the meaning information, and transmit the acquired meaning information to the terminal so as to be displayed on the display screen; to generate, based on the selected character string data included in the received inquiry data, a prompt sentence for requesting an explanation of the character string data from a generative information processing apparatus implementing a generative AI model, the prompt sentence including constraint information defining at least one of an upper limit of a number of characters of response text data or a representation style of the response text data; to transmit the prompt sentence to the generative information processing apparatus and receive, from the generative information processing apparatus, response text data automatically generated based on the prompt sentence and in accordance with the constraint information; to execute, on the received response text data, a character count limiting process based on a preset upper limit of the number of characters so as to adjust a length of the response text data; to transmit the adjusted response text data to the terminal so as to be displayed, on the display screen, as a user interface element associated with the selected character string data; to assign unique identification information to the inquiry data, store the unique identification information in association with the selected character string data and the response text data, and, when a display update request based on the unique identification information is received from the terminal, retransmit corresponding response text data to the terminal; and to accumulate, as statistical information, attribute information relating to the selected character string data, the prompt sentence, and the response text data, and automatically adjust at least one of the upper limit of the number of characters or a generation condition of the prompt sentence based on the statistical information. This enables the computer system, including the server and the terminal, to improve internal data handling and user interface behavior by automatically orchestrating dictionary lookup and generative AI processing, enforcing display-appropriate constraints on generated text, and adaptively optimizing prompt generation and response length control, thereby reducing user interaction steps, minimizing context switching, and enhancing the efficiency and responsiveness of the overall information retrieval function.

The term “system” refers to a combination of one or more hardware devices and software components that cooperate to execute information processing functions as claimed, including at least a server and a terminal interconnected via a communication network.

The term “processor” refers to a hardware computation unit, such as a central processing unit or other processing circuitry, configured to execute instructions of a program to perform the functions described in the claims.

The term “terminal” refers to an information processing apparatus operated by a user, such as a general-purpose computing device including a display and input interface, which communicates with the server and presents information on a display screen.

The term “user information processing apparatus” refers to an electronic device that performs at least data input, processing, and output operations for a user, including devices such as computers, communication devices, and mobile computing devices.

The term “display screen” refers to a visual output interface of the terminal, such as a monitor or integrated display panel, on which characters, images, and user interface elements are presented.

The term “inquiry data” refers to data transmitted from the terminal to the server that includes at least a character string selected by a user and optionally additional metadata, and that requests processing related to the selected character string.

The term “character string data” refers to data representing one or more characters, symbols, or text segments in a digital format that can be displayed on the display screen and processed by the system.

The term “selected character string data” refers to character string data that has been explicitly designated by a user through a selection operation on the display screen and that serves as a basis for subsequent processing.

The term “dictionary storage device” refers to a storage resource, such as a memory device or database system, that retains structured dictionary information mapping character strings to corresponding meaning information.

The term “meaning information” refers to information describing a definition, explanation, or semantic content of a character string, obtained from the dictionary storage device for presentation to the user.

The term “prompt sentence” refers to a text string generated by the processor and supplied as input to a generative information processing apparatus, the text string including at least the selected character string data and optionally constraint information, and functioning as an instruction for generating response text data.

The term “generative information processing apparatus” refers to an information processing system, local or remote, that implements a generative AI model and is configured to generate text or other content in response to a prompt sentence.

The term “generative AI model” refers to a computational model based on machine learning techniques, such as a neural network, that is trained to generate natural language text or other content in response to input data including a prompt sentence.

The term “response text data” refers to text generated by the generative information processing apparatus in response to a prompt sentence, which is received by the server and processed for display to the user.

The term “character count limiting process” refers to a procedure executed by the processor to evaluate the number of characters in response text data and to truncate or otherwise adjust the text so that its length does not exceed a predetermined upper limit.

The term “upper limit of a number of characters” refers to a predefined maximum allowable number of characters for response text data or other text content, used by the processor to control output length.

The term “user interface element” refers to a discrete visual component displayed on the display screen, such as a text bubble, label, or panel, that presents information to the user and may be associated with selected character string data.

The term “unique identification information” refers to data, such as an identifier or code, that uniquely distinguishes a particular instance of inquiry data and enables association and retrieval of corresponding processing results.

The term “display update request” refers to a request transmitted from the terminal to the server that includes unique identification information and instructs the server to provide or update response text data for presentation on the display screen.

The term “attribute information” refers to metadata associated with selected character string data, prompt sentences, or response text data, including, for example, length, language type, timestamps, or other descriptive properties.

The term “statistical information” refers to aggregated or accumulated data derived from multiple instances of attribute information, used by the processor to analyze patterns and to adapt processing conditions.

The term “generation condition of the prompt sentence” refers to a parameter or rule used by the processor when constructing a prompt sentence, including conditions related to content, constraint information, or formatting of the prompt sentence.

The term “display language type” refers to information indicating a language or locale specification used for displaying meaning information and response text data on the display screen.

In one embodiment, a server and a terminal cooperate to implement the claimed system. The server includes at least one processor, a main memory, a nonvolatile storage device, and a network interface card. The terminal includes at least one processor, a main memory, a display device, an input interface such as a touchscreen, and a wireless communication unit. The server and the terminal communicate via a communication network such as a packet-based wide area network using a transport protocol such as TCP/IP over a secure protocol such as HTTPS.

The terminal executes an application program, for example a messaging-type application implemented using a mobile operating system framework such as an application framework for a handheld device. The terminal presents a text-based user interface on the display screen and allows the user to perform a selection operation on one or more character strings. The terminal uses an operating system text rendering component (for example, a text view component that supports selection ranges) to detect and store a selection range in a buffer in system memory. The terminal converts the selection range into character string data according to a character encoding scheme such as UTF-8 or UTF-16.

The terminal constructs inquiry data containing at least the selected character string data, a unique identification information value, and a display language type. The terminal generates the unique identification information value, for example as a universally unique identifier, and stores the identifier in association with the selected character string data in a local data structure, such as a key-value mapping maintained in main memory. The terminal transmits the inquiry data to the server using an HTTP client library via the wireless communication unit.

The server receives the inquiry data through the network interface and stores the received data in a request buffer in main memory. The server processor parses the inquiry data according to a predetermined message format and extracts the selected character string data, the unique identification information, and the display language type. The server processor accesses a dictionary storage device, which may be implemented as a relational database or a key-value store residing on a storage medium. The server uses the selected character string data as a key to query the dictionary storage device and reads meaning information describing a definition and basic explanation of the selected character string data. The server transmits the acquired meaning information to the terminal. The terminal receives the meaning information and renders it on the display screen adjacent to the original selected character string data as a user interface element, for example a small bubble or overlay.

In parallel, the server generates a prompt sentence that will be supplied to a generative information processing apparatus implementing a generative AI model. The server constructs the prompt sentence in a structured manner using a prompt generation module. This module reads the selected character string data and a set of constraint parameters from a configuration data structure stored in nonvolatile memory. The constraint parameters include at least a maximum number of characters for a response and a representation style type. The server concatenates these elements into a textual prompt sentence. Examples of such prompt sentences include:
“Please explain the meaning of ‘algorithm’ in a concise way within 150 characters, focusing only on the definition.”
“Please explain the meaning of ‘quantum entanglement’ in simple English, within 180 characters. Answer briefly and clearly.”
“Please explain the meaning of ‘machine learning’ in a way that is easy for beginners to understand, within 150 characters.”
“Describe the meaning of ‘cloud computing’ in Japanese, in about 100 characters, avoiding technical jargon.”

The server embeds explicit constraint information into the prompt sentence, such as “within 150 characters,” “in simple English,” or “avoiding technical jargon.” The server also stores an association between the prompt sentence, the selected character string data, and the unique identification information in a structured record in main memory, and may persist this record in a database for later analysis.

The server communicates with the generative information processing apparatus via an application programming interface exposed over a secure network connection. The generative information processing apparatus includes an AI accelerator or general-purpose processor and a memory storing a generative AI model. In one embodiment, the generative AI model is a transformer-based neural network comprising an embedding layer, a plurality of self-attention layers, and an output projection layer. Each self-attention layer includes multi-head attention sublayers and feed-forward sublayers with nonlinear activation functions. The model parameters include weight matrices and bias vectors that have been learned from a large corpus of text data.

The generative AI model has been trained using supervised learning and unsupervised pre-training. During pre-training, the model processes sequences of tokens representing natural language text and optimizes a likelihood objective that minimizes a cross-entropy loss between predicted tokens and ground-truth tokens. The training procedure uses gradient-based optimization, such as stochastic gradient descent or an adaptive variant, to update model weights. The training data may be augmented using data augmentation techniques such as random masking, shuffling within limited windows, or paraphrase generation, to improve robustness.

The server supplies the prompt sentence to the generative information processing apparatus along with generation parameters such as a maximum number of tokens, a temperature parameter controlling randomness, and a top-k or top-p sampling configuration. The generative AI model converts the prompt sentence into token identifiers using a tokenization algorithm, such as byte-pair encoding or a similar subword segmentation procedure. The model embeds the tokens into a continuous vector space and processes them through the transformer layers. Each layer computes self-attention weights that depend on learned query, key, and value projections applied to the token embeddings, and aggregates contextual information across the sequence. The output layer produces a probability distribution over possible next tokens. The generative information processing apparatus iteratively samples or selects tokens according to the specified generation parameters until a stop condition is satisfied, such as reaching a token limit or an end-of-sequence symbol.

The generative information processing apparatus returns the generated response text data to the server. The server receives the raw response text data and stores it in an output buffer. The server then performs a character count limiting process. In this process, the server computes the number of characters in the response text data, considering the encoding used on the terminal device. The server counts code points or code units and compares the count to the upper limit of the number of characters specified either in the prompt sentence or in a configuration parameter. If the count exceeds the upper limit, the server truncates the response text data at a boundary that avoids cutting a multi-byte character or a combining mark, and optionally performs additional trimming to avoid leaving incomplete words or sentences.

The server further post-processes the response text data by removing redundant prefixes or politeness phrases, standardizing line breaks, and ensuring compatibility with the display language type. The server may apply rule-based normalization, such as converting multiple consecutive whitespace characters into a single space, or converting incompatible control characters to safe substitutes. By performing this character count limiting and normalization process on the server side, the system optimally shapes the response text data for the limited display region available on the terminal, reducing rendering overhead and network waste. The server then transmits the adjusted response text data to the terminal, together with the unique identification information. The terminal receives the adjusted response text data and locates the corresponding user interface element by matching the unique identification information to locally stored state. The terminal updates the chat-style display on the display screen by inserting or modifying a bubble or annotation adjacent to the original selected character string data, thereby presenting both the dictionary-based meaning information and the generative AI-based explanation within a constrained visual space.

The server accumulates attribute information relating to the selected character string data, the prompt sentences, and the response text data. This attribute information may include, for example, character length of selected strings, language type, time of day, length of generated responses before and after truncation, and user interaction outcomes such as whether a user requested additional detail. The server stores the attribute information in a database and periodically performs statistical analysis, such as computing histograms of response lengths or distributions of truncation ratios.

Based on this statistical information, the server automatically adjusts generation conditions for subsequent prompt sentences. For example, if the server observes that responses for technical terms in a certain language are frequently truncated, the server may reduce the maximum number of characters specified in the prompt sentence and increase a strictness parameter that instructs the generative AI model to answer more concisely. Conversely, if responses are consistently shorter than the limit and user requests for more detail are common, the server may increase the maximum character limit or modify representation style instructions to include examples. This adaptive adjustment improves computational efficiency because the generative AI model is asked to generate text within bounds that more closely match the final usable size, reducing unnecessary token generation and downstream truncation.

The terminal and the server together implement specific data structures and processing flows that improve computer functionality beyond simple display of text. The terminal maintains an in-memory mapping from unique identification information to positions of text segments on the display screen. This mapping allows the terminal to re-render or update explanation bubbles quickly without re-computing layout from scratch, thereby improving rendering performance and lowering processor load on resource-constrained devices. The server maintains an indexed database of inquiry records keyed by unique identification information, enabling efficient retrieval of prior responses and reduction of redundant processing in repeated or related queries.

The use of the generative AI model in this system differs from simple human task automation, because the server embeds explicit character-length and style constraints into the prompt sentences and further enforces hardware-aware constraints through the character count limiting process informed by terminal capabilities. This arrangement results in reduced data transmission sizes, lower memory usage at the terminal, and shorter rendering times. The generative AI model is not merely replacing manual text drafting; instead, it operates in a constrained feedback loop with the server's statistical optimization module, which adjusts generation conditions to improve computational resource usage over time.

In another embodiment, the server may employ an alternative generative AI model architecture, such as a recurrent neural network with attention, or a smaller distilled transformer optimized for low latency. The training procedure for such models may use a different loss function, such as a weighted cross-entropy that emphasizes concise outputs, or may introduce an auxiliary loss term that penalizes outputs exceeding a target token count during training. This additional training structure allows the generative AI model to produce more compact outputs by design, further reducing the need for post-generation truncation and improving end-to-end latency.

In yet another embodiment, the server may store multiple prompt generation templates tuned for different device classes or network conditions. For example, when the server detects that the terminal uses a small-screen device or operates under low bandwidth, the server selects a template that produces shorter and more direct explanations. When the terminal is a large-screen device, the server may select a template that allows more descriptive explanations within a larger character limit. This dynamic template selection is performed by the server based on device metadata included in the inquiry data, and it contributes to efficient use of display and communication resources.

The system thus improves computer technology by optimizing data flows, response generation, and display rendering in a coordinated manner between the server and the terminal. The server reduces computation and network bandwidth by tailoring the generative AI model's output to device constraints and user context, and the terminal reduces rendering complexity by relying on stable unique identification information and structured inquiry-response associations. As a result, response latency decreases, the ratio of useful characters to transmitted characters increases, and the probability of visual overflow or clipping on the display screen is reduced.

Because the system uses explicit machine-level rules for prompt construction, constraint embedding, post-processing, and adaptive optimization, the processing differs from conventional human reading and summarizing activities. The server and the terminal process structured data and perform algorithmic transformations that exploit the capabilities of modern hardware and neural network models in a nonconventional way, producing a measurable improvement in processing speed, data management efficiency, and output quality within the constraints of real-world devices and communication networks.

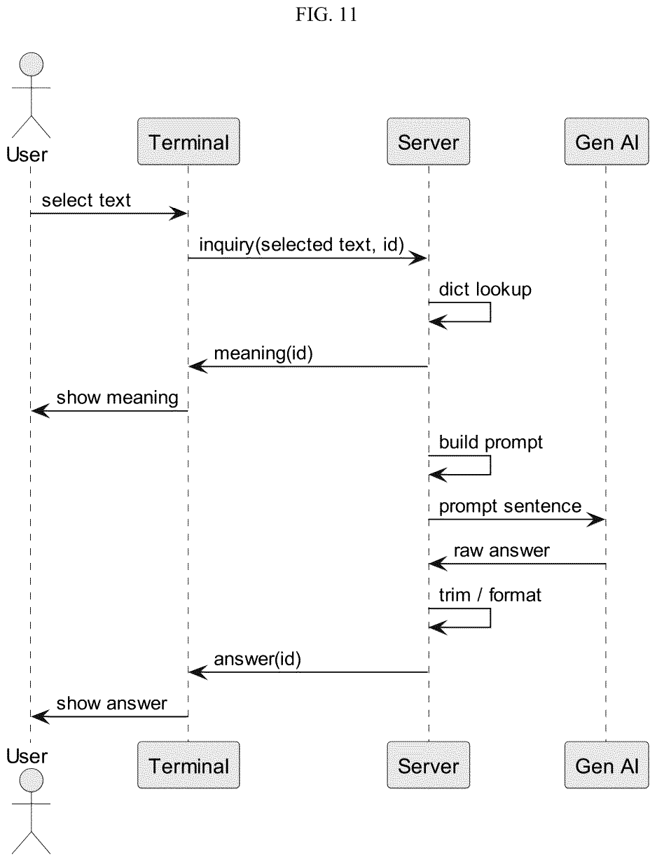

The following describes the processing flow using FIG. 11.

### Step 1:

The user performs a text selection operation on the terminal.
The user long-presses or drags on a portion of text displayed in a messaging screen on the terminal's display. As input, the terminal receives touch coordinates and gesture events from the touchscreen hardware. The terminal converts these touch events into a selection range in the rendered text using the operating system's text layout engine. As output, the terminal obtains selected character string data (for example, “algorithm” or “machine learning”) and a corresponding position in the displayed message.

### Step 2:

The terminal converts the selection range into normalized character string data.
The terminal takes the selected range in the text view as input and reads the underlying characters from a text buffer stored in main memory. The terminal removes leading and trailing whitespace, normalizes the character encoding (for example, normalizes Unicode to NFC), and verifies that the length is within a predefined limit. As output, the terminal produces a clean character string suitable for further processing, such as “algorithm” without extra spaces or control characters.

### Step 3:

The terminal generates a unique identification information value and constructs inquiry data.
The terminal receives the normalized character string as input and calls a unique ID generator (for example, a UUID module) to produce an identifier that will be used to correlate the request and response. The terminal then builds an inquiry data structure including the selected character string, the unique identification information, and a display language type derived from application settings. As output, the terminal produces a structured inquiry object held in memory, ready to be serialized and sent to the server.

### Step 4:

The terminal transmits the inquiry data to the server over the network.
The terminal takes the inquiry object as input, serializes it into a message format such as JSON, and passes it to an HTTP client library. The terminal uses the communication module (for example, Wi-Fi or mobile network) to send an HTTPS POST request to a server endpoint. As output, the terminal produces a network packet containing the inquiry data and a pending request state awaiting the server's response.

### Step 5:

The server receives and parses the inquiry data.
The server uses the network interface to accept the incoming HTTPS request as input. The server decodes the message, verifies transport-level security, and parses the body to reconstruct the inquiry data structure. The server extracts fields such as the selected character string, the unique identification information, and the display language type. As output, the server produces an internal representation of the inquiry, stored in working memory for subsequent processing.

### Step 6:

The server queries a dictionary storage device to obtain meaning information.
The server takes the selected character string from the parsed inquiry as input and forms a database query against a dictionary storage device, such as a relational database table mapping terms to definitions. The server executes the query, retrieves a matching record, and reads the associated meaning information. As output, the server obtains dictionary meaning text and combines it with the unique identification information into a response fragment destined for the terminal.

### Step 7:

The server transmits dictionary meaning information to the terminal.
The server uses the meaning information and unique identification information as input to construct a partial response message. The server serializes this data into a response body and sends it back to the terminal via the network interface as an HTTP response or as a separate message. As output, the server produces a network transmission that allows the terminal to display dictionary data before the generative AI response is ready, reducing perceived latency.

### Step 8:

The terminal receives and displays the dictionary meaning information.
The terminal takes the server's response as input, parses the message to extract the meaning information and the unique identification information, and matches the identifier to the original selected text position stored in its local mapping. The terminal then creates or updates a user interface element, such as a small bubble adjacent to the selected string, and writes the meaning text to the display buffer. As output, the terminal presents an immediate dictionary explanation on the display screen near the user's selection.

### Step 9:

The server generates a prompt sentence for the generative AI model.
The server uses the selected character string and configuration parameters (such as maximum characters and style) as input to a prompt generation module. The server concatenates fixed template text with the selected string and constraint information. For example, the server generates:
“Please explain the meaning of ‘algorithm’ in a concise way within 150 characters, focusing only on the definition.”
or
“Please explain the meaning of ‘machine learning’ in a way that is easy for beginners to understand, within 150 characters.”

As output, the server produces a complete prompt sentence string to be used as input to the generative AI model.

### Step 10:

The server sends the prompt sentence to the generative information processing apparatus.
The server takes the prompt sentence and related generation parameters (maximum tokens, temperature, etc.) as input to an API client module. The server formats these values in a request structure and transmits the request via HTTPS to the generative information processing apparatus that hosts the generative AI model. As output, the server emits a model query that will cause the external apparatus to begin neural network inference.

### Step 11:

The generative AI model generates response text data based on the prompt sentence.
The generative information processing apparatus receives the prompt sentence as input and tokenizes it into subword units using a tokenizer. The apparatus embeds the tokens into continuous vectors and processes them through multiple transformer layers composed of self-attention and feed-forward networks. At each decoding step, the model computes probability distributions over candidate tokens and selects the next token under specified sampling rules until a stop condition is reached. As output, the apparatus returns a sequence of tokens that are converted back into human-readable response text data, such as a concise explanation of the selected term.

### Step 12:

The server receives and buffers the generated response text data.
The server obtains the AI apparatus's response as input, parses the response object, and extracts the generated text string from the appropriate field. The server stores this text in a response buffer in memory, associated with the unique identification information for the original inquiry. As output, the server has raw response text data that may exceed the desired length or contain formatting artifacts.

### Step 13:

The server applies a character count limiting process to the response text data.
The server uses the raw response text data and the configured upper limit of the number of characters as input to a length control module. The server counts the characters in the response, taking into account the encoding and multi-byte characters. If the count exceeds the upper limit, the server truncates the string at a safe boundary and removes trailing incomplete fragments or redundant whitespace. The server may also strip unnecessary prefixes such as “Sure,” or “Here is the explanation:”. As output, the server produces adjusted response text data whose length is guaranteed not to exceed the configured maximum.

### Step 14:

The server stores statistical attribute information related to the interaction.
The server takes the selected character string, the prompt sentence, and the adjusted response text data as input and computes attribute information such as lengths, language type, and whether truncation occurred. The server writes this attribute information into a statistical database, updating aggregates such as average response length or truncation frequency. As output, the server maintains an evolving statistical profile that will later influence prompt generation and character limit settings.

### Step 15:

The server sends the adjusted response text data to the terminal.
The server uses the adjusted response text data and the unique identification information as input to construct a final response message. The server serializes this message and transmits it via the network interface to the terminal. As output, the server delivers a concise, display-ready explanation that matches the original inquiry.

### Step 16:

The terminal receives and associates the adjusted response text data with the selected text.
The terminal accepts the server's response as input, parses the message body, and extracts the adjusted response text data and unique identification information. The terminal consults its local mapping from unique identification information to display positions and identifies the user interface element that corresponds to the original selected character string. As output, the terminal prepares updated content for the corresponding display region.

### Step 17:

The terminal updates the chat-style user interface to display the generative explanation.
The terminal takes the adjusted response text data and the target UI element position as input and updates or creates a chat-style bubble or overlay attached to the selected character string. The terminal writes the new text into the display buffer using the UI framework, applies style attributes (such as font size and color), and triggers a redraw of the relevant screen area. As output, the terminal shows the generative AI model's concise explanation directly next to the user's original selection in the messaging interface.

### Step 18:

The user views and optionally interacts with the displayed explanation.
The user receives the explanation visually as input and may choose to tap the bubble, request more detail, or close the explanation. If the user taps a “more detail” control, the terminal creates new inquiry data with a modified maximum character constraint and possibly a different style instruction, such as:
“Please explain the meaning of ‘algorithm’ in more detail, suitable for a university student, within 300 characters.”

As output, the user's action causes the terminal to repeat earlier steps with updated parameters, and the system refines subsequent responses.

### Step 19:

The server adjusts future generation conditions based on accumulated statistics.
The server uses the stored statistical information as input to an optimization routine that analyzes distributions of selected text lengths, response lengths, and truncation rates. The server updates configuration parameters, such as default character limits and template phrases in prompt sentences, to reduce average truncation and align generated outputs more closely with actual screen capacity. As output, the server produces new configuration values that are applied in future prompt generation, thereby improving computational efficiency and the quality of on-device presentation over time.

### APPLICATION EXAMPLE 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional information presentation systems that provide explanations of terms to users, for example by looking up dictionary information or by querying a remote service, often suffer from several technical shortcomings when deployed on head-mounted or other constrained display devices. First, such systems typically rely on static dictionary lookups that return generic definitions without considering the specific context in which a term is selected, such as a product description, an instruction manual, or a specialized domain. As a result, the returned information is frequently irrelevant or too general, thereby forcing the user to perform additional operations and increasing interaction latency.

Second, when an external generative AI model is integrated to generate more tailored explanations, existing systems tend to issue ad hoc or fixed prompts that do not systematically exploit contextual information such as usage situation, device type, or user role. This leads to non-deterministic and verbose responses, which are technically problematic for devices having limited display areas, processing resources, and strict latency constraints, such as smart glasses or other information presentation devices worn by a user.

Third, current architectures generally treat the generative AI interaction as a black box and do not implement a structured, programmatic pipeline for prompt generation, response length control, and caching. Without automatic prompt sentence generation based on context templates, without deterministic application of character limits with optional AI-based summarization, and without reuse of frequently requested responses, the system consumes excessive communication and computation resources. This degrades real-time performance, increases server load, and results in inconsistent response times and unstable user experience.

Fourth, on the client side, existing systems do not tightly integrate the properties of the information presentation device, such as display resolution and field of view, with the formatting of AI-generated responses. As a consequence, the rendering engine may overflow the display area, require manual scrolling, or obscure important parts of the user's field of view. These issues represent concrete technical problems in the human-computer interface and in the way textual information is composed, transmitted, and rendered on resource-constrained devices.

Accordingly, there is a need for a computer-implemented system that improves the underlying data processing and communication techniques by: (i) automatically transforming user-selected phrases and associated context into structured prompt sentences for a generative AI model, (ii) enforcing deterministic character limits using a programmable pipeline including truncation and AI-based summarization, (iii) caching frequently used phrases and their responses to reduce redundant AI calls and network usage, and (iv) coordinating server-side response generation with client-side rendering constraints of a wearable information presentation device. Such a system should improve latency, bandwidth efficiency, relevance, and readability of AI-generated content, thus constituting a concrete improvement in computer technology rather than merely automating a mental process.

The specific processing by the specific processing unit 290 of the data processing device 12 in Application Example 1 is realized by the following means.

The present invention provides a server comprising a processor configured to receive, via a communication network from a terminal functioning as an information presentation device worn by a user, phrase information including a phrase selected by the user via gaze input or contact input, to query a dictionary information storage unit based on the received phrase information to acquire meaning information and to transmit the meaning information to the terminal for display, to generate a prompt sentence for instructing a generative artificial intelligence model to generate a predetermined response by selecting, based on context information indicating a usage situation in which the phrase is presented, one template from among a plurality of predetermined templates and inserting the selected phrase into the selected template, to transmit the generated prompt sentence to the generative artificial intelligence model via the communication network and to receive response information described in natural language from the generative artificial intelligence model, to determine a length of the received response information based on a preset character limit and, when the character limit is exceeded, to generate adjusted response information by either truncating the response information at a predetermined number of characters or generating an additional summarization prompt sentence and transmitting the summarization prompt sentence to the generative artificial intelligence model to acquire summarized response information, and to transmit the adjusted response information to the terminal so that the adjusted response information is superimposed and displayed in real time in a display area of the information presentation device, and optionally further configured to store, in an associated storage unit, frequently used phrases and corresponding response information and, when phrase information identical or similar to previously received phrase information is received, to read corresponding response information from the storage unit and transmit the corresponding response information to the terminal prior to querying the generative artificial intelligence model. This enables a technical improvement in computer-based information presentation by providing context-sensitive prompt generation, deterministic response length control, and cache-based response reuse, thereby reducing communication overhead, stabilizing response latency, and optimizing formatting and rendering of generative AI outputs on resource-constrained wearable display devices.

The term “system” refers to a combination of hardware components and software components that cooperate via at least one communication network to execute the claimed processing, including a processor, a terminal, storage units, and an information presentation device.

The term “processor” refers to a hardware computation unit, such as a central processing unit or a microcontroller, configured by executable instructions to perform the steps of receiving data, generating prompt sentences, communicating with a generative AI model, applying character limits, and transmitting adjusted responses.

The term “terminal” refers to an electronic device that communicates with the processor via a communication network, and that functions as an interface between the user and the server-side processor, including receiving user inputs, transmitting phrase information, and displaying meaning information and adjusted response information.

The term “information presentation device” refers to a display-capable device worn or used by a user, such as a head-mounted display, smart glasses, or another wearable display apparatus, that presents visual information including meaning information and adjusted response information to the user.

The term “user” refers to a human operator who wears or uses the information presentation device, performs gaze input or contact input to select phrases, and visually perceives the information displayed by the terminal.

The term “phrase” refers to any linguistic unit, including a word, a term, or a sequence of words, that is presented on the information presentation device and that can be selected by the user for further explanation or information retrieval.

The term “phrase information” refers to data representing a phrase selected by the user, optionally including metadata such as language, context, device identification, or other attributes used by the processor to generate a prompt sentence or to query storage units.

The term “gaze input” refers to an input method in which the user's line of sight or eye position is detected by a sensor system and interpreted by the terminal as a selection operation on a displayed phrase.

The term “contact input” refers to an input method in which the user performs a physical interaction, such as a touch, tap, or press on a touch sensor, button, or similar input interface of the information presentation device or the terminal, thereby selecting a phrase.

The term “communication network” refers to any wired or wireless data communication infrastructure, including local area networks, wide area networks, and public networks, that enables data exchange between the terminal, the processor, and external services.

The term “dictionary information storage unit” refers to a storage resource, such as a database or memory structure, that stores dictionary entries, definitions, or meaning information associated with phrases, and that can be queried by the processor.

The term “meaning information” refers to definition data, explanation data, or interpretive data obtained from the dictionary information storage unit that describes the semantic content of a phrase selected by the user.

The term “context information” refers to data indicating a usage situation in which a phrase is presented, including but not limited to content type, domain, application state, user role, or device status, which the processor uses to select an appropriate prompt template.

The term “prompt sentence” refers to a natural-language instruction or query generated by the processor and transmitted to a generative AI model to cause the generative AI model to generate response information related to a selected phrase and its context.

The term “template” refers to a predefined textual pattern or structure for a prompt sentence, including fixed portions and variable placeholders, into which the processor inserts at least the selected phrase and optionally context information to form a complete prompt sentence.

The term “generative artificial intelligence model” refers to a machine learning model trained to generate natural-language text in response to input prompts, and that is accessed by the processor as an external service via the communication network.

The term “response information” refers to natural-language text generated by the generative artificial intelligence model in response to a prompt sentence, including explanations, descriptions, or other information related to the selected phrase.

The term “character limit” refers to a constraint on the maximum allowed number of characters for response information to be displayed on the information presentation device, used by the processor to control the length of generated text.

The term “adjusted response information” refers to response information that has been processed by the processor to conform to the character limit, including response information that has been truncated or summarized prior to transmission to the terminal.

The term “summarization prompt sentence” refers to a prompt sentence generated by the processor that instructs the generative artificial intelligence model to produce a condensed version of previously obtained response information within a specified character limit.

The term “summarized response information” refers to response information generated by the generative artificial intelligence model in response to a summarization prompt sentence, having reduced length while preserving key content.

The term “display area” refers to a region of the information presentation device in which visual information, including meaning information and adjusted response information, is rendered and presented to the user.

The term “real time” refers to a response behavior in which the time interval from user selection of a phrase to the display of adjusted response information on the information presentation device is sufficiently short that the user perceives the system as responding without perceptible delay.

The term “line feed” refers to a layout control operation by which the terminal determines where to break lines of text when rendering the adjusted response information in the display area.

The term “character size” refers to a parameter controlling the visual size of text glyphs used to display adjusted response information in the display area, which is adjusted based on display resolution and field of view.

The term “display resolution” refers to the number of addressable display elements in the information presentation device, typically expressed in horizontal and vertical pixel counts, that constrains the layout of the adjusted response information.

The term “field of view” refers to an angular or spatial extent of the visual region presented by the information presentation device, within which the adjusted response information is superimposed for viewing by the user.

The term “storage unit” refers to a memory device or data store, such as a non-volatile memory, volatile memory, or database system, that stores phrases, response information, templates, character limits, or other configuration data used by the processor.

The term “frequently used phrase” refers to a phrase that has been selected by users with a frequency exceeding a predetermined threshold or according to a defined usage criterion, as determined by the processor based on logged interaction history.

The term “frequently used response information” refers to response information that has been transmitted to terminals with a frequency or pattern exceeding a predetermined threshold, and that is retained in the storage unit for potential reuse.

The term “response presentation time” refers to a time interval from the receipt of phrase information by the processor to the display of corresponding adjusted response information on the information presentation device, which the system aims to reduce through caching and length control.

The server cooperates with the terminal and the user to implement the invention using specific hardware, software, and data processing structures as described below. The embodiments described herein support the scope of the claims and enable a person skilled in the art to implement the claimed system.

The server executes software on a hardware platform that includes at least one central processing unit, a main memory, a non-volatile storage device, and a network interface. The server uses an operating system such as a UNIX-like operating system or a general-purpose server operating system, and uses a web application framework such as a scripting-language-based framework or a compiled-language-based framework. The server further uses an application programming interface client library provided for communication with a generative AI model service. The server stores dictionary information, prompt templates, usage logs, and cached response information in a database management system such as a relational database or a key-value store.

The terminal operates as an information presentation device or as a controller of an information presentation device. The terminal includes a processor, a memory, a wireless communication circuit, and at least one display unit. In one embodiment, the terminal is integrated into a head-mounted display device such as smart glasses, in which a microdisplay and optical waveguides are mounted in a frame worn by the user. In another embodiment, the terminal is a handheld device such as a smartphone that communicates with a separate head-mounted display via a short-range wireless link. The terminal runs an embedded operating system such as a mobile operating system or a customized real-time operating system, and executes an application that handles user input, communication with the server, and rendering of textual information on the display.

The user wears or holds the information presentation device and views content such as product information, manuals, or other textual content. The user operates the device using gaze input, contact input, or voice input. For gaze input, the terminal uses an image sensor or infrared sensor to track eye position and to determine which displayed phrase the user is fixating on for a predetermined dwell time. For contact input, the terminal uses a capacitive touch sensor, mechanical button, or touchpad mounted on the frame or housing of the device. The terminal converts these physical interactions into selection events identifying a specific phrase on the display.

The terminal uses a text-rendering subsystem that maintains a mapping between screen coordinates and text positions. When the user selects a phrase by gaze or contact, the terminal translates the selection coordinates into a character offset range in the underlying text buffer. The terminal then extracts the corresponding phrase string, encodes the phrase string as text data (for example, using a Unicode encoding), and constructs phrase information including the phrase, a language code, context information (such as “product_description” or “instruction_manual”), and device-specific identifiers. The terminal transmits this phrase information to the server through a secure communication protocol over a wireless or wired network.

The server receives the phrase information and parses it to obtain at least the phrase and the context information. The server uses a dictionary information storage unit, implemented as a database containing lexical entries, to obtain meaning information. The server constructs a query using the phrase string as a key, retrieves one or more definition records, and generates meaning information in a format suitable for display. The server then transmits this meaning information to the terminal so that the user can view a conventional dictionary-like explanation.

The server also generates a prompt sentence for a generative AI model based on the phrase and the context information. The server uses a template storage unit that holds a plurality of textual templates. Each template is associated with conditions such as context type, user role, or device type. The server selects an appropriate template by comparing the received context information with the template conditions. For example, when the context is “product_description,” the server selects a template such as:
“Please explain the details of the term ‘[TERM]’ as it relates to this product, in language suitable for a retail customer.”

When the context is “instruction_manual,” the server selects a different template such as:
“Please explain the term ‘[TERM]’ in the context of operating this device, focusing on safety and correct usage.”

The server inserts the phrase into the placeholder [TERM] to generate a prompt sentence. In other embodiments, the server uses templates such as:
“Please explain the meaning of the word ‘[TERM]’ in simple terms.”
“Please summarize the key information about ‘[TERM]’ for a non-expert user within 200 characters.”
“Provide important cautions or usage notes related to ‘[TERM]’.”

The server uses these prompt sentences to construct requests for a generative AI model. The generative AI model is implemented as a neural network-based language model that includes multiple layers of self-attention mechanisms and feed-forward sublayers. In one embodiment, the generative AI model is a transformer-based model having a plurality of encoder-decoder blocks or decoder-only blocks, each block including multi-head self-attention, layer normalization, and position-wise linear transformations. The generative AI model is trained in advance on large-scale text corpora using a next-token prediction objective. During training, the model receives sequences of tokens representing text and learns parameters (weights and biases) by minimizing a cross-entropy loss function between predicted tokens and ground-truth tokens. The model updates weights using an optimization algorithm such as stochastic gradient descent with momentum or adaptive methods. The training procedure may also employ techniques such as regularization, gradient clipping, and data augmentation by masking or shuffling.

The server does not perform model training during normal operation but instead uses the trained generative AI model in an inference mode. The server transmits the prompt sentence to the generative AI model service via an API, specifying parameters such as maximum token length, sampling temperature, and top-k or top-p sampling thresholds. These parameters control the generative behavior, such as balancing determinism and variability. The generative AI model computes token probabilities given the prompt and sequentially produces a sequence of tokens representing the response information.

The server receives the generated response information and applies a character limit control process. The server converts tokens to a character string, measures the number of characters, and compares the count to a preset character limit that is stored in configuration. The server selects one of two non-conventional control paths. When the response does not exceed the character limit, the server marks the response as adjusted response information without modification. When the response exceeds the limit, the server either truncates the response or generates an additional summarization prompt sentence.

In a truncation embodiment, the server uses a substring operation to cut the response at the character limit and optionally appends a continuation indicator string. This operation is deterministic and ensures that the visual rendering on the terminal will never exceed the designed display area.

In a summarization embodiment, the server uses the original response information as input to a new prompt sentence. For example, the server generates a summarization prompt sentence such as:
“Summarize the following explanation within 200 characters, keeping the key benefits clear for a retail customer: [ORIGINAL_RESPONSE].”

The server transmits this summarization prompt to the generative AI model. The generative AI model produces summarized response information that is shorter than the original response but preserves key semantic content. The server then measures the length again and, if necessary, iteratively adjusts parameters or truncates further. This multi-step interaction between the server and the generative AI model implements a dedicated algorithmic pipeline for length control that is tailored to the constraints of a wearable display.

The server stores relationships between phrases and resulting response information in a storage unit. The server records each phrase, context information, prompt sentence, and final adjusted response information, along with metadata such as timestamp and frequency of use. The server periodically analyzes logs to determine frequently used phrases and frequently used response information. The server caches these entries in a structure such as a key-value map indexed by normalized phrase strings and context categories. When the server later receives phrase information that is identical or similar to a cached phrase, the server retrieves the corresponding response information from the storage unit and directly transmits it to the terminal without invoking the generative AI model. The server thereby reduces network traffic, decreases response presentation time, and stabilizes latency.

The terminal receives the meaning information and the adjusted response information from the server. The terminal parses the received data and passes the text to a layout engine that computes line breaks, character size, and positioning. The terminal uses the display resolution and the field of view properties of the information presentation device to determine the maximum number of characters per line and the number of lines that can be shown without obstructing critical regions in the user's view. The terminal dynamically adjusts character size based on these constraints and on user-specific preferences. The terminal then renders the adjusted response information as an overlay within the display area. Because the server enforces a character limit and optionally uses summarization, the amount of text is aligned with the visual limits of the display, reducing the need for scrolling or pagination.

The server and the terminal together improve computer technology by introducing a specialized data flow and control sequence that is not a mere automation of human reading or explaining. The server uses structured phrase information, context-specific prompt templates, deterministic length control, and caching mechanisms to reshape how natural-language content is generated and adapted for constrained devices. The server reduces communication load by avoiding unnecessary large responses and repeated generative AI calls. The summarization loop with explicit parameter control improves computational efficiency by shifting part of the length-optimization work to the generative AI model in a controlled manner. The terminal improves rendering efficiency by relying on pre-adjusted text that fits display constraints, reducing local computation for layout and avoiding frame drops in the display pipeline.

The generative AI model operates with internal attention weights and learned representations that differ from human heuristic reasoning. The model uses multi-head attention to compute relevance scores between every pair of tokens in the prompt sentence, based on learned query, key, and value projections. Each attention head uses a dot-product scoring function scaled by a normalization factor, followed by a softmax function to obtain attention weights. The model then combines values with these weights to produce contextualized token representations. Such operations constitute a specific mathematical architecture implemented in hardware accelerators such as graphics processors or specialized tensor processing units.

The server benefits from this architecture by obtaining responses that are context-sensitive and coherent, while still imposing external control through the prompt design and length constraints.

The server distinguishes the present system from conventional dictionary lookup services or static FAQ systems by using a multi-stage rule set for prompt selection and response adjustment. For example, the server chooses different templates not only based on context type but also based on a history of user interactions. When a user repeatedly selects technical terms, the server may choose templates that emphasize detailed explanations, whereas for a novice user the server may choose templates that emphasize simplicity. The server can implement these rules as a decision table or as a small classifier model that maps context features to template identifiers. This rule-based or model-based selection is executed consistently, leading to predictable and controllable behavior, unlike ad hoc manual prompt phrasing.

The system generates technical effects in the domains of processing speed, accuracy, and communication efficiency. The server reduces the average time from user selection to display by using caching, by limiting text length, and by minimizing the number of network round trips. The system improves accuracy of displayed information because the generative AI model produces responses tailored to context, and the server ensures that the final text is readable and complete within the visual constraints. The system reduces communication load because it transmits only character-limited text and reuses frequently requested responses instead of requesting new responses from the generative AI model for every selection. Alternative embodiments can modify the hardware and software components without departing from the scope of the invention. In one embodiment, the terminal is a vehicle-mounted display device and the user is a driver who selects terms on a navigation display. In another embodiment, the terminal is a large-screen display in an industrial environment, and the user selects terms in operational manuals. The server can also be distributed across multiple machines, with separate modules for dictionary lookup, prompt generation, AI communication, and caching. The generative AI model can be hosted on a local server within an organization in an on-premises configuration instead of being accessed as an external service.

The server can use different generative AI models depending on domain or resource constraints. For example, the server can select a smaller, faster model for quick approximate explanations, and a larger model for complex technical explanations. The server can maintain separate character limits for different device types and adjust its summarization prompts accordingly. In another variation, the terminal can maintain its own small language model for local summarization of server responses, further reducing server load.

Through these embodiments, the server, the terminal, and the user cooperate in a specific technical configuration that implements context-aware prompt sentence generation, structured interaction with a generative AI model, deterministic character limit control, and optimized rendering on an information presentation device. These components and processing flows collectively yield improvements in computing efficiency, data handling, and human-machine interface quality, thereby constituting a concrete technical implementation rather than an abstract idea.

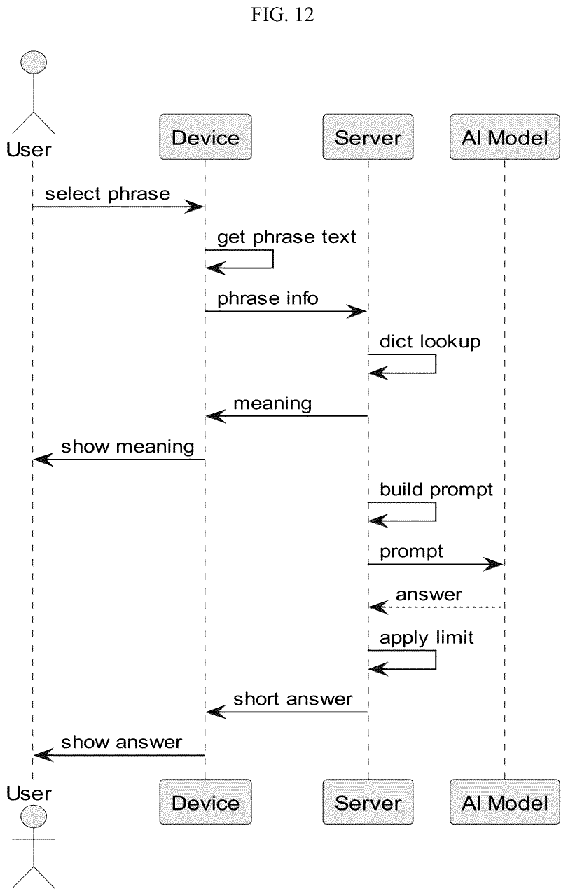

The following describes the processing flow using FIG. 12.

### Step 1:

The user operates the information presentation device to select a phrase.
The user views text displayed on the device, such as a product description, and performs a gaze input or contact input to select a specific phrase. The input of this step is the visual content presented to the user and the physical action (eye fixation, tap, or touch) performed by the user. The output of this step is a selection event that identifies a screen position or region corresponding to the selected phrase.

### Step 2:

The terminal detects the selection event and extracts phrase information.
The terminal receives the selection event as input, including coordinates or an item identifier on the display. The terminal uses its text-layout mapping to translate the screen position into a character index range in the underlying text buffer. The terminal then extracts the corresponding phrase string, encodes it in a text format, and associates it with metadata such as language code, context type, and device identifier. The output of this step is structured phrase information including at least the selected phrase and context information.

### Step 3:

The terminal transmits the phrase information to the server via a communication network.
The terminal takes the phrase information as input and serializes it into a message format suitable for network transmission, such as a structured text payload. The terminal establishes a secure communication channel to the server, sets necessary headers, and sends the message. The output of this step is a network request, delivered to the server, that contains the phrase information.

### Step 4:

The server receives the phrase information and queries dictionary information.
The server receives the network request as input and parses the contained phrase information. The server extracts the phrase string and uses it as a key to access a dictionary information storage unit. The server performs a lookup operation, retrieves one or more entries related to the phrase, and constructs meaning information in a format suitable for display. The output of this step is meaning information associated with the selected phrase.

### Step 5:

The server transmits the meaning information to the terminal.
The server takes the meaning information as input to a response-generation process for dictionary data. The server encapsulates the meaning information into a response message and sends it back to the terminal over the communication network. The output of this step is a network response carrying the meaning information for presentation to the user.

### Step 6:

The terminal displays the meaning information on the information presentation device.
The terminal receives the meaning information as input and passes it to a rendering component. The terminal computes line breaks and character size based on the display resolution and field of view, and overlays the meaning information on the display so that it does not obstruct critical visual regions. The output of this step is a visual representation of the meaning information that the user can read.

### Step 7:

The server generates a context-dependent prompt sentence for the generative AI model.
The server uses the phrase information (phrase string and context information) as input to a prompt-generation module. The server selects a template from a set of stored templates by matching the context information to template conditions, and then inserts the phrase string into the template placeholder. The server may also append additional instructions, such as character limits or audience level. The output of this step is a complete prompt sentence, for example: “Please explain the details of the term ‘material’ as it relates to this product, in language suitable for a retail customer.”

### Step 8:

The server transmits the prompt sentence to the generative AI model and receives response information.
The server uses the prompt sentence as input to a generative-AI-communication module. The server calls an application programming interface for the generative AI model, specifying the prompt sentence and configuration parameters such as maximum token count and sampling temperature. The generative AI model processes the prompt sentence using its internal neural network and returns a sequence of tokens representing a natural-language response. The server decodes the tokens into a character string. The output of this step is raw response information in natural-language text form.

### Step 9:

The server applies character limit control to the response information.
The server takes the raw response information and a preset character limit as input. The server calculates the length of the response string, compares it with the character limit, and branches the processing. When the length is within the limit, the server designates the response information as adjusted response information without modification. When the length exceeds the limit, the server performs a data processing operation: it either truncates the string at the character limit or generates an additional summarization prompt, such as “Summarize the following explanation within 200 characters, keeping the key points clear for the user: [original response],” and sends this summarization prompt to the generative AI model. The server then receives summarized response information and verifies that its length satisfies the character limit. The output of this step is adjusted response information that conforms to the character limit.

### Step 10:

The server stores and reuses frequently used phrases and responses.
The server uses the phrase information and the adjusted response information as input to a caching module. The server updates statistics such as usage count and last access time in a storage unit, associating the phrase and context with the adjusted response. When new phrase information is received in later operations, the server compares it to stored entries using exact match or similarity criteria. If a match is found, the server reads the corresponding response information from storage instead of calling the generative AI model. The output of this step is either a cached adjusted response or an indication that a cache miss occurred and that AI processing is required.

### Step 11:

The server transmits the adjusted response information to the terminal.
The server takes the adjusted response information, whether newly generated or retrieved from cache, as input to a response-generation module. The server constructs a response message containing the text and any control flags (for example, an indicator that the character limit was applied) and sends the message to the terminal over the communication network. The output of this step is a network response that delivers the adjusted response information to the terminal.

### Step 12:

The terminal renders the adjusted response information on the display.
The terminal receives the adjusted response information as input and forwards it to a layout engine. The terminal performs data processing that computes suitable font size, line breaks, and overlay position, using device parameters such as display resolution and field of view as inputs to these calculations. The terminal composes a drawing command list and writes pixel values to the display buffer so that the text appears superimposed in the designated region. The output of this step is a rendered overlay containing the adjusted response information on the information presentation device.

### Step 13:

The user reads the displayed information and optionally initiates further interactions.
The user receives the visual output produced by the terminal as input through the user's visual perception. The user interprets the meaning and may decide to select another phrase within the adjusted response information or elsewhere on the display. The user then performs a new gaze input or contact input, which the terminal again converts into a selection event. The output of this step is a new selection event that can serve as a new input to the entire processing flow, enabling iterative refinement and additional explanations.

It is also possible to incorporate an emotion engine for estimating the user's emotions. That is, the specific processing unit 290 may estimate the user's emotions using an emotion identification model 59, and perform specific processing based on the estimated emotions.

### EXAMPLE 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information processing systems that provide explanations of user-selected phrases on a display screen typically suffer from several technical limitations. In many implementations, a terminal device transmits the selected phrase directly to a remote service or dictionary database and displays a full, unbounded textual response. As a result, the response is often verbose, exceeds the capacity of the display region, and requires excessive scrolling and cognitive effort by the user. This leads to inefficient use of display resources, increased network traffic, and degraded responsiveness of the user interface.

Furthermore, in systems that incorporate a generative AI model, the lack of coordinated control between the terminal device and the server device over prompt sentence generation and response length frequently causes redundant communication and unnecessary processing. For example, the terminal may send poorly formatted or noisy text as input to the generative AI model, which in turn produces a long and inconsistent answer requiring additional post-processing. This results in increased processing load on server-side components, higher latency from input to display, and unstable user experience across different devices and network conditions.

In addition, conventional systems generally do not provide a unified, end-to-end control flow that tightly couples: (i) detection and preprocessing of the selected phrase at the terminal, (ii) generation of a structured prompt sentence conforming to the constraints of the generative AI model, (iii) application of explicit response-length constraints during model invocation at the server, and (iv) enforcement of character count limits at the time of rendering on the terminal. The absence of such an integrated control mechanism prevents effective optimization of the data flow, hinders predictable behavior of the generative AI model, and complicates maintenance and scalability of the overall system.

Moreover, many existing user interfaces fail to provide clear feedback to the user while the system is performing background processing, such as network transmission and remote model inference. The lack of progress-indicating visual information results in perceived delays, user confusion, and premature cancellation of operations, thereby reducing the effective throughput and reliability of the human-computer interaction.

Accordingly, there is a need for a system and method that improve the underlying computer technology by: (i) structuring the interaction between terminal device and server device to ensure that the selected phrase is normalized and validated before being converted into a prompt sentence, (ii) coordinating prompt sentence generation and explicit response-length constraints in the invocation of a generative AI model at the server, and (iii) enforcing character count limits and progress-indicating visual feedback at the terminal during the entire processing sequence from phrase selection to display. Such improvements should reduce unnecessary data transmission, lower server and network load, shorten end-to-end latency, and enhance the usability and predictability of the system from the standpoint of computer performance and interface control.

The specific processing by the specific processing unit 290 of the data processing device 12 in Example 2 is realized by the following means.

The present invention provides a server comprising a processor configured to cooperate with a terminal device to detect, based on a user operation at the terminal device, a phrase selected on a display device and acquire the selected phrase as character information; to cause the terminal device to perform preprocessing on the acquired phrase including deletion of blank characters and verification of a length of the phrase, and to generate a prompt sentence including the phrase only when the phrase is determined to be valid; to receive, at the server, the prompt sentence transmitted from the terminal device via a communication network; to call a generative AI model via an external information processing service by using the prompt sentence as input while transmitting constraint information relating to a length of a response; to receive response information from the generative AI model; to adjust the response information to display response information by performing character string processing based on both the constraint information and a character count limit; and to transmit the display response information to the terminal device for display in a predetermined region of a display screen together with visual information indicating a processing progress status during processing from selection of the phrase to display of the display response information. This enables an improvement of computer technology by reducing unnecessary data transmission and processing through validation and normalization of input phrases at the terminal, by constraining the behavior of the generative AI model at the server with explicit response-length control, by enforcing predictable character count limits prior to rendering, and by providing synchronized progress indications at the terminal, thereby decreasing end-to-end latency, stabilizing resource consumption, and enhancing the efficiency and usability of the system as a whole.

The term “system” refers to a combination of one or more hardware devices and one or more software components that cooperate via at least one communication path to execute the processing described in the claims.

The term “processor” refers to a hardware processing unit, such as a central processing unit or a microcontroller, that executes instructions to perform logical, arithmetic, and control operations implementing the claimed functions.

The term “user” refers to a human operator who interacts with a terminal device by performing input operations such as touch, click, or key input.

The term “terminal device” refers to an information processing device, such as a personal computer, a smartphone, or a tablet, that provides a display device and an input interface to allow the user to view content and perform operations.

The term “server device” refers to an information processing device, such as a physical server or a virtual machine in a data center or cloud environment, that executes backend processing and communicates with one or more terminal devices via a communication network.

The term “display device” refers to hardware for visually presenting information, such as a liquid crystal display, an organic light-emitting diode display, or any equivalent display unit integrated with or connected to a terminal device.

The term “display screen” refers to a logical display area provided by the display device in which graphical user interface elements and textual information are rendered.

The term “phrase” refers to a contiguous sequence of one or more characters, words, or symbols displayed on the display screen that can be selected by the user as a unit of text.

The term “character information” refers to digital data representing one or more characters, such as letters, digits, symbols, or whitespace, encoded according to a character encoding scheme.

The term “user operation” refers to an input action performed by the user, such as a touch gesture, a mouse operation, or a keyboard operation, that can be detected and interpreted by the terminal device.

The term “prompt sentence” refers to a natural-language text string, generated based on the phrase, that is formatted for input to a generative AI model in order to request a response.

The term “character string processing” refers to operations performed on character information, including at least concatenation, deletion, truncation, substitution, and length measurement of character sequences.

The term “communication network” refers to a wired or wireless network infrastructure, including at least one of a local area network, a wide area network, or a public network, that enables data transfer between the terminal device and the server device.

The term “generative AI model” refers to a computational model implementing artificial intelligence techniques that receives input data in the form of a prompt sentence and generates output data in the form of response information by performing natural language processing.

The term “external information processing service” refers to a remote computing service accessible via the communication network that provides access to the generative AI model through an application programming interface.

The term “response information” refers to text data generated by the generative AI model in response to the prompt sentence, prior to any post-processing for display.

The term “display response information” refers to response information after being adjusted, including at least truncation or formatting based on a character count limit or constraint information, for presentation on the display screen.

The term “character count limit” refers to a predetermined upper bound on the number of characters allowed in a character string to be displayed in a particular display region.

The term “constraint information” refers to metadata or parameter data specifying at least a target length or size for response information generated by the generative AI model.

The term “predetermined region” refers to a specific area of the display screen, defined by the terminal device or application, in which the display response information is to be presented.

The term “visual information indicating a processing progress status” refers to graphical or textual elements, such as progress bars, spinning indicators, or status messages, that inform the user of the current state of processing from phrase selection to display of the display response information.

The term “preprocessing” refers to operations applied to the acquired phrase before generation of the prompt sentence, including at least removal of blank characters and verification that the phrase satisfies predetermined validity conditions.

The term “blank characters” refers to characters that represent spacing or separation, including at least space characters, tab characters, and line break characters.

The term “verification of a length of the phrase” refers to a determination process that confirms whether the number of characters or other length measure of the phrase falls within a predetermined acceptable range.

The term “valid phrase” refers to a phrase that satisfies one or more predetermined conditions, including at least a condition related to the length of the phrase and absence of disallowed characters, and is thereby accepted for use in generating the prompt sentence.

The term “final length of the display response information” refers to the number of characters or equivalent length metric of the display response information after all processing based on the constraint information and the character count limit has been completed.

In one embodiment, a system includes a server and one or more terminals interconnected via a communication network. The server includes at least one hardware processor, a main memory, a non-volatile storage device, and a network interface controller. The terminal includes at least one hardware processor, a main memory, a display device such as a liquid crystal display or an organic light-emitting diode display, a touch input sensor or pointing device, and a wireless or wired network interface.

The terminal executes an operating system such as a mobile operating system or a desktop operating system, and an application such as a web browser, an electronic document viewer, or a native application. The server executes an operating system such as a server-oriented operating system and a server-side application framework such as a web application framework. The server further communicates with an external information processing service that provides access to a generative AI model implementing natural language processing.

The terminal performs detection of a phrase selected by the user on the display screen. The user touches, clicks, or otherwise indicates a range of text within displayed content, and the terminal uses input event handling mechanisms provided by the operating system and application framework to identify the selected phrase. For example, the terminal uses a text selection API to obtain a start position and an end position within a text buffer, and retrieves character information encoded in a character encoding scheme.

The terminal performs preprocessing of the acquired phrase. The terminal removes blank characters such as leading and trailing spaces, tab characters, and line breaks, and verifies that a length of the phrase is within a predetermined range in terms of number of characters or number of code points. The terminal discards phrases that are too short, too long, or contain disallowed characters. This preprocessing reduces noise in the subsequent processing pipeline and prevents unnecessary network requests and server-side computation.

The terminal generates a prompt sentence based on the validated phrase. The terminal uses a phrase-normalization module that inserts the phrase into a natural language template stored in a configuration data structure. The terminal performs character string processing, including concatenation and insertion, to create a prompt sentence suitable for input to a generative AI model. The terminal may select a template type according to a mode setting. Example prompt sentences include:
“What is blockchain?”
“Explain blockchain in one concise sentence suitable for a beginner.”
“What does the term ‘machine learning’ mean? Answer in under 100 words.”
“Explain the phrase ‘quantum computing’ in simple English.”
“What is the meaning of the phrase ‘supply chain management’? Provide a brief definition.”

The terminal enforces local format constraints on the prompt sentence, such as a maximum character count and permitted character classes, and may truncate or sanitize the prompt sentence accordingly. By enforcing these constraints at the terminal, the system avoids transmitting malformed or excessively long requests to the server, which improves communication efficiency.

The server receives the prompt sentence from the terminal via the communication network. The server parses a request message, validates a structure of the data, and stores the prompt sentence in a request-handling module. The server maintains a log in a persistent storage device to record, in association, a request identifier, a timestamp, and the prompt sentence. This logging enables performance monitoring and debugging and can be structured using log rotation and indexing to support efficient retrieval.

The server invokes a generative AI model hosted by an external information processing service. In one embodiment, the generative AI model is implemented as a transformer-based neural network. The server transmits the prompt sentence and constraint information, such as a maximum number of tokens, a target response length category, and a decoding parameter, to the external service using an application programming interface.

The generative AI model includes an encoder-decoder architecture or a decoder-only architecture with multiple self-attention layers and feed-forward layers. Each layer contains weight matrices and bias vectors trained on large-scale text corpora. The model internally represents the prompt sentence as a sequence of token embeddings, applies positional encodings, and performs multi-head self-attention operations to derive contextual representations. The model calculates, for each token position, attention scores using a scaled dot-product operation, normalizes the scores with a softmax function, and computes weighted sums of value vectors. The model propagates these representations through stacked layers and uses a final linear layer and a softmax layer to output probability distributions over a vocabulary for each subsequent token.

The server uses, at training time of the generative AI model, a learning procedure that minimizes an error function such as cross-entropy loss between predicted token distributions and ground-truth token indices. The model parameters are updated using an optimization algorithm such as stochastic gradient descent with adaptive learning rate control. The learning process uses techniques such as mini-batch processing, gradient clipping, and regularization. Data augmentation and token masking may be employed to improve generalization. Although the training may be performed in a separate environment, the inference behavior of the trained model, as used by the system, is determined by these learned parameters and architectures.

The server interprets the constraint information for response length within the inference request. The server sets parameters such as a maximum generated token count, a minimum generated token count, and a penalty coefficient for repeated tokens. The server thus biases the generative AI model to produce responses that are concise and free from unnecessary redundancy. This parameter control is not a mere post hoc truncation, but affects the internal decoding process of the model, for example by limiting beam search depth or sampling iterations, which reduces computation time and memory usage in the external service.

The server receives response information generated by the generative AI model. The response information is returned as a sequence of tokens that the server converts into a character string in a target encoding. The server stores the response information in an intermediate buffer and performs character string processing based on a character count limit. The server determines an optimal cutoff position such that the character count of the display response information does not exceed the limit while preserving semantic completeness, for example by attempting to cut at sentence boundaries or delimiter positions. This processing may use a data structure that maps character indices to token boundaries, enabling consistent truncation without splitting multibyte characters.

The server combines the constraint information used for generation and the character count limit applied for display to determine a final length of the display response information. This dual-stage length control reduces the variance of output lengths and ensures that the response can be rendered in a predetermined region of the display screen without reflow or layout failure. By performing this coordinated control, the system reduces the need for repeated requests or scrollable containers, thereby improving user interface stability and server throughput.

The server transmits the display response information to the terminal. The terminal receives the display response information, integrates it into a user interface layout, and renders it in a predetermined region associated with the selected phrase. The terminal controls the display to show visual information indicating processing progress during the period from phrase selection to completion of display. For example, the terminal may display a progress indicator near the selected phrase or in a status area of the screen while the network request and model inference are in progress. When the display response information arrives, the terminal hides the progress indicator and replaces it with the response text.

The server and the terminal, by cooperating in this manner, provide technical effects beyond simple automation of human tasks. The terminal performs local validation and normalization of the phrase, which reduces bandwidth usage and avoids unnecessary server computation on invalid data. The server applies explicit response-length constraints at the time of model invocation, which reduces model inference time and resource consumption. The combined length control at both model level and display level results in predictable response sizes and improved layout performance on the terminal.

The system improves processing speed by minimizing unnecessary network round trips and by shortening the maximum response length handled by the generative AI model. The system improves accuracy and relevance of displayed information by providing the model with clean, structured prompt sentences rather than arbitrary raw selections. The system improves data management by maintaining structured logs and by using deterministic preprocessing rules that can be consistently applied across terminals. The system improves computational efficiency by aligning model parameters, server-side truncation rules, and terminal-side display constraints, thereby reducing redundant trimming and reformatting.

The server uses rule-based logic and non-conventional processing flows that are distinct from typical human reading and summarization. For instance, the server applies an algorithm that uses both token-level statistics and character-level indices to select an optimal truncation point. The server may use a heuristic, such as a threshold on sentence-ending punctuation density, to decide where to cut the response. These rules are implemented to exploit internal structures of the model output and the hardware-specific performance characteristics of the server, and would not be available in a manual reading context.

In one variation, the terminal caches frequently used phrases and corresponding display response information in a local data store. The terminal consults this cache before generating a new prompt sentence, and if a matching entry exists, the terminal displays the cached response without invoking the server. This reduces network traffic and lowers latency, which is a direct improvement in communication efficiency.

In another variation, the server maintains a phrase-response index in a database. The server computes a hash or a normalized representation of prompt sentences and associates them with previously generated display response information. When the server receives a prompt sentence, the server looks up the index before invoking the generative AI model. If a sufficiently similar entry is found according to a similarity metric, the server can reuse or adapt the stored response. This reduces the number of generative AI model invocations, decreasing load on external hardware accelerators and improving overall throughput.

In yet another variation, the terminal adjusts the type of prompt sentence according to a device profile. For example, when the terminal is a small-screen device, the terminal selects templates that produce shorter responses, such as “Explain [phrase] in one sentence.” In contrast, when the terminal is a larger-screen device, the terminal may select templates that allow slightly longer responses. These variations show how the system controls display behavior and processing load based on hardware characteristics.

The described embodiments demonstrate how the server and the terminal cooperate with a generative AI model to provide concise explanations of user-selected phrases with reduced latency, controlled resource usage, and predictable display behavior. By integrating specific data structures, neural network parameters, and coordinated length-control algorithms, the system improves computer technology itself, rather than merely automating human reading and explanation tasks.

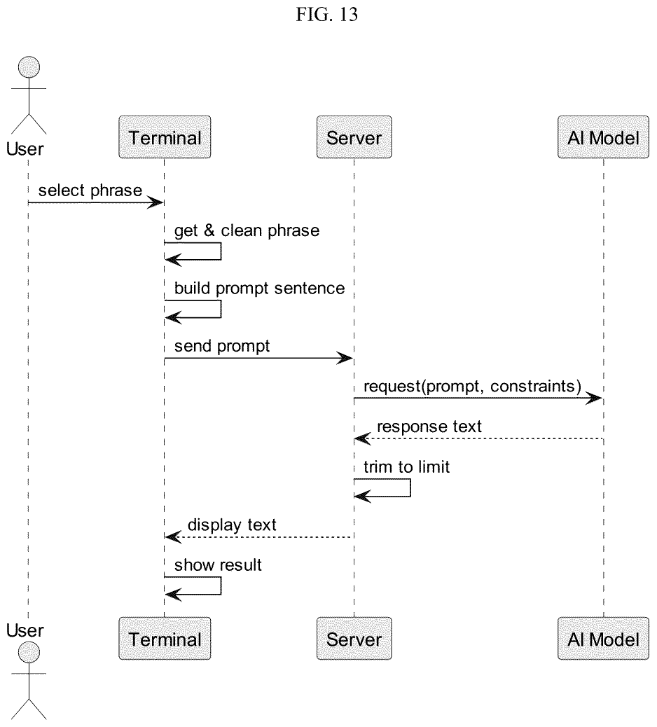

The following describes the processing flow using FIG. 13.

### Step 1:

The user selects a phrase on the display screen of the terminal.
The user performs an input operation such as touching, clicking, or dragging across text displayed in an application on the terminal.
Input: visual content rendered on the terminal and a user gesture (touch, mouse, or keyboard).
Output: a selection range indicating a start position and an end position in the displayed text.
The terminal records the selection range in memory by using operating system text-selection APIs and associates it with the underlying text buffer.

### Step 2:

The terminal acquires the selected phrase as character information.
The terminal calls a text retrieval function provided by the operating system or application framework to read the characters within the selection range.
Input: the selection range (start and end indices) in the text buffer.
Output: a raw phrase string, for example “blockchain \n”.
The terminal copies the corresponding characters from the text buffer into a new string object stored in working memory.

### Step 3:

The terminal preprocesses the acquired phrase.
The terminal removes blank characters such as leading spaces, trailing spaces, tab characters, and line breaks, and verifies that the number of characters is within a predetermined range.
Input: the raw phrase string.
Output: a validated phrase string or a failure indication.
The terminal applies character-level operations (trimming, scanning, length counting) and, if the phrase is empty, too short, too long, or contains disallowed characters, the terminal sets a flag indicating that the selection is invalid and stops further processing.

### Step 4:

The terminal generates a prompt sentence based on the validated phrase.
The terminal inserts the phrase into a template sentence stored in configuration data, such as “What is [phrase]?” or “Explain the phrase ‘[phrase]’in simple terms.”
Input: the validated phrase string and a prompt template.
Output: a prompt sentence string, for example “What is blockchain?”.
The terminal performs string concatenation or interpolation to combine the template and the phrase, and stores the resulting prompt sentence in memory for later transmission.

### Step 5:

The terminal normalizes the prompt sentence and applies local format constraints.
The terminal checks the length of the prompt sentence and ensures that it consists of permitted character classes, and if necessary truncates or sanitizes it.
Input: the initial prompt sentence string.
Output: a normalized prompt sentence string that satisfies local constraints.
The terminal computes the character count, replaces or escapes problematic characters, and if the length exceeds a maximum, cuts the string and appends a delimiter such as “?”.

### Step 6:

The terminal packages the prompt sentence into a request message for the server.
The terminal constructs a data structure including the prompt sentence and optional metadata such as language code and device type.
Input: the normalized prompt sentence and device metadata.
Output: a serialized request payload suitable for network transmission.
The terminal encodes the data structure as a text format, sets appropriate headers, and places the encoded data into a send buffer managed by the network stack.

### Step 7:

The terminal sends the request message to the server and starts progress indication.
The terminal transmits the request payload to the server via a communication network and updates the user interface to show a visual progress indicator.
Input: the serialized request payload and a destination network address of the server.
Output: a network packet stream sent over the network and a visible loading indicator on the display.
The terminal invokes a network API to open or reuse a connection, writes the payload to the socket, and renders a progress icon or message near the selected phrase.

### Step 8:

The server receives the request and extracts the prompt sentence.
The server accepts the incoming network connection, reads the request headers and body, and parses the payload.
Input: the network packet stream representing the request.
Output: an internal representation of the prompt sentence and associated metadata.
The server reconstructs the request from the packet stream, decodes the payload text, and stores the prompt sentence string in a request-handling object in memory.

### Step 9:

The server validates the prompt sentence and logs the request.
The server checks that the prompt sentence is non-empty, within allowed length, and properly encoded, and records the request for monitoring.
Input: the prompt sentence string and request metadata.
Output: a validated prompt sentence and a log entry.
The server performs string-length calculation and character checks, and if valid, writes a record including timestamp, anonymized identifier, and a hash of the prompt sentence to a persistent log; otherwise, the server may generate an error response.

### Step 10:

The server prepares constraint information and model invocation parameters.
The server determines a maximum token count, a target response length, and decoding parameters to control the generative AI model.
Input: system configuration, device metadata, and the validated prompt sentence.
Output: a set of model invocation parameters including length constraint information.
The server selects values such as maximum tokens, minimum tokens, and repetition penalties based on configuration tables and stores them together with the prompt sentence in a model-request structure.

### Step 11:

The server invokes the generative AI model via an external information processing service.
The server sends the prompt sentence and constraint information to the external service that hosts the generative AI model.
Input: the model-request structure (prompt sentence plus parameters).
Output: an inference request transmitted to the external service.
The server serializes the model-request structure, sets authentication data, and writes the request to an outbound network connection targeting the external model endpoint.

### Step 12:

The generative AI model generates response information based on the prompt sentence and constraints.
The model converts the prompt sentence into tokens, computes context representations through multiple neural network layers, and decodes a sequence of output tokens subject to the length constraints.
Input: the prompt sentence tokens and the model invocation parameters.
Output: a sequence of output tokens representing the response information.
The model applies tokenization, embedding lookup, self-attention operations, and a decoding algorithm such as greedy decoding or sampling, stopping when the maximum token count or an end-of-sequence condition is reached.

### Step 13:

The server receives and decodes the response information from the generative AI model.
The server accepts the response from the external service and converts the returned tokens into a text string.
Input: the token sequence or encoded response payload.
Output: a raw response text string.
The server parses the returned data, maps token identifiers back to characters or subwords via a vocabulary table, concatenates the decoded pieces, and stores the complete response string in memory.

### Step 14:

The server applies character-count-based adjustment to create display response information.
The server enforces a character count limit on the raw response text to produce a concise version suitable for the terminal display.
Input: the raw response text and the character count limit.
Output: adjusted display response information.
The server computes the character length of the response, determines an allowable cutoff position that does not exceed the character count limit, and truncates the string at a boundary such as a sentence end; the server may append an ellipsis to indicate truncation.

### Step 15:

The server constructs a response message for the terminal.
The server embeds the display response information and optional flags such as truncation indicators into a response data structure.
Input: the display response information and processing metadata.
Output: a serialized response payload ready for transmission to the terminal.
The server encodes the data structure, sets response headers, and writes the encoded content into an outbound buffer in the server network stack.

### Step 16:

The server sends the response message to the terminal.
The server transmits the payload over the communication network to the terminal that issued the original request.
Input: the serialized response payload and the terminal's network address.
Output: a network packet stream carrying the display response information.
The server uses its network interface to send the packets and closes or maintains the connection according to a connection management policy.

### Step 17:

The terminal receives the response and stops the progress indication.
The terminal obtains the response payload from the network stack and removes the visual loading indicator from the display.
Input: the network packet stream containing the response payload.
Output: a decoded response data structure and an updated user interface state without the progress indicator.
The terminal decodes the payload, extracts the display response information, and updates the rendering logic to hide the progress icon or message.

### Step 18:

The terminal renders the display response information in the predetermined region.
The terminal places the response text in a user interface component such as a popup, tooltip, or side panel near the originally selected phrase.
Input: the display response information and layout configuration.
Output: a visual representation of the response text on the display screen.
The terminal computes layout positions, sets font and style properties, and issues drawing commands to the graphics subsystem so that the response appears within the predefined area.

### Step 19:

The user reads the displayed response and may trigger further actions.
The user views the concise explanation associated with the originally selected phrase and decides whether to close the panel or request more detail.
Input: the visual representation of the display response information.
Output: a subsequent user operation, such as closing the display or selecting another phrase.
The user may tap a “More” control or select another phrase, which causes the terminal to repeat the sequence from phrase acquisition.

### Step 20:

The terminal optionally generates a follow-up prompt sentence based on user feedback.
The terminal creates a new prompt sentence that asks for additional or different information, such as a more detailed explanation or an example.
Input: the original phrase, the existing display response information, and a user command for more detail.
Output: a second prompt sentence, for example “Explain blockchain in more detail, including one concrete example.”
The terminal combines the phrase and a new template, performs string processing to form the follow-up prompt sentence, and then repeats the communication and generation flow starting from request packaging.

### APPLICATION EXAMPLE 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional information processing systems that assist users in understanding text selections suffer from several technical limitations. When a user encounters an unfamiliar phrase on a display screen, the user typically has to switch applications or open separate resources, such as standalone dictionary applications or web search interfaces. This context switching interrupts the current human-computer interaction flow, increases latency in information acquisition, and burdens both the user interface and the underlying communication and processing subsystems.

Furthermore, systems that merely query a dictionary database and return a fixed definition do not adapt to heterogeneous user contexts and do not exploit available computational resources to generate dynamic, context-aware explanations. Such systems treat all phrases and users uniformly and ignore contextual signals such as the type of screen in which the phrase appears or the user's current emotional state inferred from utterance information. As a result, the returned explanations can be semantically correct but suboptimal with respect to length, tone, or detail level, leading to unnecessary data transfer, increased rendering load on terminals, and reduced usability in constrained display environments.

In addition, naïve integrations of generative artificial intelligence models into client-server architectures often delegate prompt construction to application code in an ad hoc manner, produce variable-length responses that are not coordinated with display capabilities, and do not systematically control the behavior of the generative model based on structured metadata. Such approaches generate responses that are excessively long, redundant, or stylistically inappropriate, thereby wasting network bandwidth, storage, and processing resources required for post hoc trimming or manual editing on the client side.

Moreover, existing systems generally do not leverage automatically inferred emotion information in a technically structured way to control prompt sentences supplied to a generative artificial intelligence model. Even when an emotion recognition component is present, its output is often used only for superficial presentation changes on the client, rather than being integrated into the server-side control logic that governs input to the model and enforces character-length constraints. This disjoint use of emotion data misses the opportunity to tailor model behavior at the prompt level and to perform server-side optimization of response content before it reaches the terminal.

Accordingly, there is a need for an improved computer-implemented system that, within a client-server architecture, (i) automatically acquires user text selections together with screen-type information, (ii) retrieves structured meaning information from a word storage resource, (iii) computes emotion information from user utterance information using an emotion recognition model, and (iv) generates and transmits to a generative artificial intelligence model a prompt sentence that encodes the selected phrase, the emotion information, and explicit character-length limitation information. There is a further need for the server to receive a response sentence from the generative artificial intelligence model, apply a length control process in accordance with the character-length limitation information, and then provide to the terminal both dictionary-based meaning information and an adjusted response sentence suitable for constrained display. By technically integrating dictionary lookup, emotion-aware prompt generation, and server-side length control for generative model output, the system can reduce processing and communication overhead, improve the consistency and suitability of generated explanations, and enhance the efficiency and reliability of the overall human-computer interaction.

The specific processing by the specific processing unit 290 of the data processing device 12 in Application Example 2 is realized by the following means.

The present invention provides a server comprising a processor configured to acquire, from a terminal functioning as an information processing device, selection information indicating a phrase selected by a user on a display screen and screen-type information indicating a type of the display screen; to refer, using the selected phrase, to a word storage resource and obtain meaning information corresponding to the selected phrase; to analyze utterance information of the user received from the terminal and calculate emotion information indicating an emotional state of the user by using an emotion recognition model; to generate, on the basis of the selected phrase and the emotion information, a prompt sentence that instructs a generative artificial intelligence model to execute a predetermined response generation process and that includes character-length limitation information; to transmit the prompt sentence to the generative artificial intelligence model and obtain, from the generative artificial intelligence model, a response sentence generated in accordance with the prompt sentence; to perform, on the basis of the character-length limitation information, a length control process on the response sentence to generate an adjusted response sentence; and to transmit the meaning information and the adjusted response sentence to the terminal so as to cause the terminal to display the meaning information and the adjusted response sentence in association with the selected phrase on the display screen. This enables the computer system to integrate dictionary lookup, emotion-based control of prompt sentences, and server-side enforcement of character-length constraints for generative artificial intelligence output, thereby improving computational efficiency, reducing unnecessary network and rendering load, and providing context-appropriate explanations that enhance the technical performance and usability of the overall information processing architecture.

The term “system” refers to an arrangement of one or more hardware components and software components that cooperate, via at least one communication network, to perform information processing functions including acquisition, analysis, generation, and display of text-based information.

The term “processor” refers to a hardware execution unit, such as a central processing unit or other programmable processing circuitry, configured by software instructions to execute operations including data acquisition, analysis, generation, and control of communications between devices and services.

The term “terminal” refers to an information processing device, such as a mobile device, a tablet device, a desktop device, or a similar computing device, that includes at least one display unit, at least one input unit, and at least one communication interface for interacting with a server.

The term “information processing device” refers to a computing apparatus that includes a processor, a memory, and at least one input/output interface, and that is capable of executing a program to process, transmit, and display digital data.

The term “display screen” refers to a display unit or graphical user interface region capable of visually presenting text, images, or other output information to a user and receiving user interactions such as selections or touch inputs.

The term “selection information” refers to data indicating a phrase or other text segment that has been designated by a user on a display screen, and may include at least a text string and position or context of the selection.

The term “phrase” refers to one or more contiguous characters, words, or symbols included in text content presented on a display screen, which are selectable by a user for obtaining additional information or processing.

The term “screen-type information” refers to data indicating a classification or category of a display screen, such as a messaging screen, a transaction screen, or a content viewing screen, used to control processing related to a selected phrase.

The term “communication network” refers to a wired or wireless communication infrastructure, including at least one of a local area network, a wide area network, or the Internet, that enables data exchange between a terminal and a server.

The term “server” refers to an information processing apparatus or group of cooperating apparatuses that provide computational services, including database access, model execution, and response generation, to one or more terminals via a communication network.

The term “word storage resource” refers to a data storage structure, such as a database, a file repository, or an external dictionary service, that stores associations between lexical items and corresponding meaning information.

The term “meaning information” refers to data representing a semantic description of a phrase, including at least one of a definition, a paraphrase, an example usage, or related linguistic attributes.

The term “utterance information” refers to text or textual data derived from user inputs, such as messages, comments, or statements, which are used as input to an analysis process including emotion recognition.

The term “emotion recognition model” refers to a computational model, implemented in software and executed on a processor, that receives utterance information as input and outputs emotion information indicating an estimated emotional state.

The term “emotion information” refers to data indicating at least one attribute of a user's emotional state, such as sadness, anger, tiredness, or excitement, optionally including a confidence value or intensity level.

The term “prompt sentence” refers to a text sequence supplied as input to a generative artificial intelligence model, the text sequence specifying conditions, instructions, or constraints that guide the generation of a response sentence.

The term “generative artificial intelligence model” refers to a machine learning model that receives a prompt sentence or similar input and produces natural-language output by performing probabilistic or neural computation over a learned parameter space.

The term “response generation process” refers to a sequence of operations executed by a generative artificial intelligence model to generate at least one response sentence in accordance with content and constraints specified in a prompt sentence.

The term “character-length limitation information” refers to data included in or associated with a prompt sentence that specifies a limit on an allowed number of characters, symbols, or tokens in a response sentence.

The term “response sentence” refers to a string of characters or tokens generated by a generative artificial intelligence model as an answer, explanation, or supplementary text in response to a prompt sentence.

The term “length control process” refers to processing executed by a processor to adjust a response sentence in accordance with character-length limitation information, including at least one of truncation, selection, or reformulation to satisfy the length constraint.

The term “adjusted response sentence” refers to a response sentence that has been modified by a length control process so that the response sentence conforms to a specified character-length limitation.

The term “display control information” refers to data transmitted from a server to a terminal, instructing the terminal how to present meaning information and an adjusted response sentence on a display screen in association with a selected phrase.

The term “tone” refers to a stylistic characteristic of an explanation, including at least one of formality, politeness, empathy level, or emotional coloring, which can be adjusted in accordance with emotion information.

The term “level of detail” refers to a degree of granularity of information in an explanation, including aspects such as length, complexity, and amount of elaboration, which can be controlled based on emotion information or context.

The term “supplementary explanation” refers to an additional or expanded description generated by a generative artificial intelligence model using meaning information as a basis, intended to complement or clarify the meaning information provided from a word storage resource.

In one embodiment, a server, a terminal, and a user cooperate to implement the claimed system. The server includes at least one processor, a main memory, a non-volatile storage device, and a network interface. The terminal includes at least one processor, a display unit, an input unit such as a touchscreen, and a wireless or wired communication interface. The server and the terminal communicate via a communication network such as the Internet, a wireless local network, or a mobile communication network.

The server executes server-side application software implemented, for example, using a web server and an application framework. The server can be realized on a general-purpose computing platform or on a cloud computing platform. The terminal executes client-side application software such as a messaging application, a web browser, or an electronic transaction application. The client-side application may be implemented as a native mobile application running on a mobile operating system, as a desktop application, or as a web application executed in a browser.

The terminal acquires user operation information through the input unit and the operating system's graphical user interface framework. When the user selects a phrase on the display screen, the terminal obtains text data representing the selected phrase together with screen-type information indicating whether the phrase is presented, for example, in a messaging screen, a transaction screen, or a content viewing screen. The terminal generates selection information including at least the selected phrase, an identifier of the display screen, and context information such as neighboring text or a conversation identifier. The terminal transmits the selection information to the server through the communication interface using a communication protocol.

The server stores a word storage resource in the non-volatile storage device or accesses an external dictionary service. The word storage resource is implemented as a relational database, a key-value store, or a full-text index structure. The server refers to the word storage resource by using the selected phrase received from the terminal as a key. The server executes a database query to retrieve meaning information including at least a base definition string, part-of-speech information, and example usage sentences. The server temporarily stores this meaning information in the main memory.

The server stores utterance information that the terminal acquires from user messages or comments entered through the input unit. The server feeds the utterance information into an emotion recognition model. In one implementation, the server uses a neural network-based natural language model for emotion recognition. The emotion recognition model is implemented as a multi-layer neural network, such as a transformer-based architecture, that receives token sequences representing the utterance information. The server converts the utterance information into token sequences using a tokenizer, embeds the tokens into numeric vectors, and supplies the vectors to the layers of the neural network.

The neural network includes an embedding layer, a plurality of self-attention layers, and a classification layer. The self-attention layers compute attention weights between tokens according to learned weight matrices and non-linear activation functions. The classification layer applies a linear transformation followed by a softmax function to produce probability values for a plurality of emotion classes, such as sadness, anger, tiredness, and excitement. The server interprets the emotion class with the highest probability as emotion information indicating an estimated emotional state of the user.

The server trains the emotion recognition model in advance by using a training dataset consisting of text samples and labeled emotion classes. During training, the server computes a loss value, such as cross-entropy loss, between predicted probabilities and true labels. The server applies a gradient-based optimization algorithm, such as stochastic gradient descent or a variant with adaptive learning rates, to update the weight parameters of the model. The server performs multiple training epochs and validation steps to achieve a desired classification accuracy. This training process enables the emotion recognition model to infer emotion information from new utterance information with higher precision than rule-based methods.

The server generates a prompt sentence for a generative AI model by integrating the selected phrase, the emotion information, and character-length limitation information. The server maintains prompt templates in the storage device. Each prompt template defines a fixed textual pattern with placeholders for the selected phrase, the emotion description, and a numeric value representing a character-length limit. The server selects a template based on the screen-type information and the emotion information. For example, when the screen type is a messaging screen and the emotion is sadness, the server selects a template configured for short, empathetic explanations.

The server replaces the placeholders in the selected template with concrete values. The server inserts the selected phrase as a literal string and converts the emotion information into a human-readable description. The server also sets a numeric limit, such as 120 or 200 characters, as character-length limitation information. As a result of this processing, the server constructs a concrete prompt sentence. Examples of such prompt sentences include:
“What is QR code payment? Explain briefly within 200 characters.”
“The user is very tired. Explain the meaning of ‘empathy’ in very simple language, within 120 characters.”
“The user is excited about blockchain. Briefly list the latest real-world applications of blockchain in less than 250 characters.”
“The user says: ‘I am very angry.’ In less than 200 characters, explain calmly why they might feel angry and offer one gentle suggestion.”

In some embodiments, the server embeds at least part of the meaning information obtained from the word storage resource into the prompt sentence. For example, the server constructs a prompt sentence such as:
“The dictionary definition of ‘empathy’ is: [definition]. Based on this, explain ‘empathy’ in friendly and simple language within 150 characters.”

By embedding the dictionary-based definition in the prompt sentence, the server constrains the generative AI model to generate a supplementary explanation aligned with the structured meaning information.

The server communicates with the generative AI model by using an application programming interface. The generative AI model is implemented as a large-scale neural language model, such as a multi-layer transformer network trained on text corpora. The generative AI model receives the prompt sentence as input, encodes the prompt into token embeddings, and processes the sequence through multiple self-attention and feedforward layers. The generative AI model predicts a probability distribution over possible next tokens and iteratively generates tokens to form a response sentence. The server supplies parameters such as maximum token length and a temperature value to influence the response generation process. By setting a maximum token length corresponding to the character-length limitation, the server pre-limits the size of the response sentence and reduces the need for later truncation.

The server receives the response sentence generated by the generative AI model and stores it in the main memory. The server performs a length control process on the response sentence based on the character-length limitation information. The server counts characters or tokens of the response sentence using a character-encoding rule and determines whether the length exceeds the limit. When the length exceeds the limit, the server applies a truncation algorithm that identifies a boundary between tokens or sentences near the limit and truncates the response sentence at that boundary. In some variants, the server passes the response sentence to a secondary summarization procedure implemented by another call to the generative AI model using a summarization-oriented prompt sentence, and then uses the summarized text as the adjusted response sentence.

The server thereby generates an adjusted response sentence that satisfies the specified length constraint. The server combines the meaning information retrieved from the word storage resource and the adjusted response sentence into a response data structure. The response data structure includes fields for the original selected phrase, the base definition, the emotion class, and the adjusted response sentence. The server transmits this response data structure to the terminal through the communication network.

The terminal receives the response data structure and configures the display unit to show the meaning information and the adjusted response sentence in association with the selected phrase. In a messaging application, the terminal displays the explanation near the selected phrase as a tooltip or in a separate message bubble that includes the base definition followed by the adjusted response sentence. In an electronic transaction application, the terminal overlays the explanation near a field label or next to a control through which the user is interacting. Because the explanation is pre-adjusted on the server side to conform to the character-length limitation information, the terminal can render the text without performing costly client-side layout adjustments or user-side manual scrolling operations.

The server further adjusts the tone and level of detail of an explanation indicated in the prompt sentence in accordance with the emotion information. When the emotion information indicates sadness or tiredness, the server inserts instructions into the prompt sentence to produce shorter, more reassuring text. When the emotion information indicates excitement, the server inserts instructions for more detailed or advanced additional information, such as examples of the latest applications. This emotion-based control modifies internal token probabilities in the generative AI model during decoding, leading to different lexical and syntactic patterns in the response sentence. As a result, the system yields explanations that are technically constrained by length and content while being adapted to the recognized emotional state.

This configuration yields technical improvements over conventional systems. The server reduces network traffic by explicitly controlling output length at the model input and by performing server-side length control before transmission to the terminal. The server reduces processor usage on the terminal and memory usage in the terminal by delivering text that is already formatted and sized for display constraints. The server improves response consistency and lowers error rates in explanation display because the server uses a standardized prompt construction mechanism and a centralized length control process instead of ad hoc truncation on multiple clients.

The emotion recognition model and the generative AI model perform computations that are not equivalent to simple human decision making or manual summarization. The emotion recognition model processes token embeddings and attention weights spanning an entire utterance and applies a learned mapping from high-dimensional feature space to discrete emotion classes. This mapping exploits co-occurrence patterns and contextual dependencies that are not easily expressed as simple rules. The generative AI model uses multi-head self-attention to simultaneously consider multiple contextual relations in the prompt sentence when selecting each token of the response sentence. These models operate on internal numeric representations of text and are optimized through iterative training procedures with loss functions and gradient updates. The system therefore applies computer-specific techniques for pattern recognition and text generation that cannot be replicated by simple automation of human actions.

The server uses data structures and modular components optimized for this architecture. The server maintains a prompt construction module that receives as input a structured record containing a phrase, screen-type information, emotion information, and dictionary-derived meaning information. The module outputs a well-formed prompt sentence string. The server also maintains a response management module that receives the raw response sentence from the generative AI model, applies a deterministic or probabilistic length control algorithm, and attaches metadata about truncation or summarization. These modules give rise to reproducible and predictable system behavior and permit optimizations such as caching frequent prompts and pre-computing emotion-dependent instruction segments.

In one alternative embodiment, the terminal executes a lightweight emotion recognition model locally, such as a smaller neural network or a rule-augmented classifier, and transmits only emotion information and selection information to the server. The server then generates the prompt sentence using the received emotion information without running the server-side emotion recognition model. This variation reduces latency and offloads part of the processing load to the terminal while preserving the server-side control of prompt generation and length limitation.

In another embodiment, the word storage resource is implemented as a layered system in which a local cache layer stores frequently accessed definitions in a high-speed memory and a backing storage layer stores a complete dictionary in a database. The server consults the cache layer first and refers to the backing storage layer only when the cache does not contain the requested entry. This structure reduces average access time for meaning information and improves overall system throughput when many terminals are simultaneously selecting phrases.

In a further embodiment, the server applies a rule-based post-filtering step after generating the adjusted response sentence. The server analyzes the response sentence using a lexical scanner and a pattern matching engine to detect overly complex terms or rare expressions. The server then modifies the response sentence by replacing such expressions with simpler synonyms using a synonym dictionary. This additional processing increases comprehensibility for users and reduces variance in explanation style among different calls to the generative AI model.

Because the server orchestrates the interactions between the word storage resource, the emotion recognition model, and the generative AI model in a structured manner and enforces prompt-level and response-level constraints, the system improves the functioning of the computer network as a whole. The system reduces redundant communication and eliminates the need for repeated queries by caching intermediate results such as meaning information and typical prompt sentence patterns. The system furthermore provides deterministic resource usage profiles because prompt length and response length are bounded by configuration. As a result, server capacity planning and network bandwidth allocation are simplified.

The described embodiments are not limited to a specific implementation technology. The server can use any suitable application framework, database engine, and neural network library capable of executing the described models and algorithms. The terminal can be any information processing device having a display, an input interface, and a network interface. Variations such as different neural network architectures, different emotion category sets, different prompt templates, and different length control algorithms can be adopted while remaining within the scope of the claimed system.

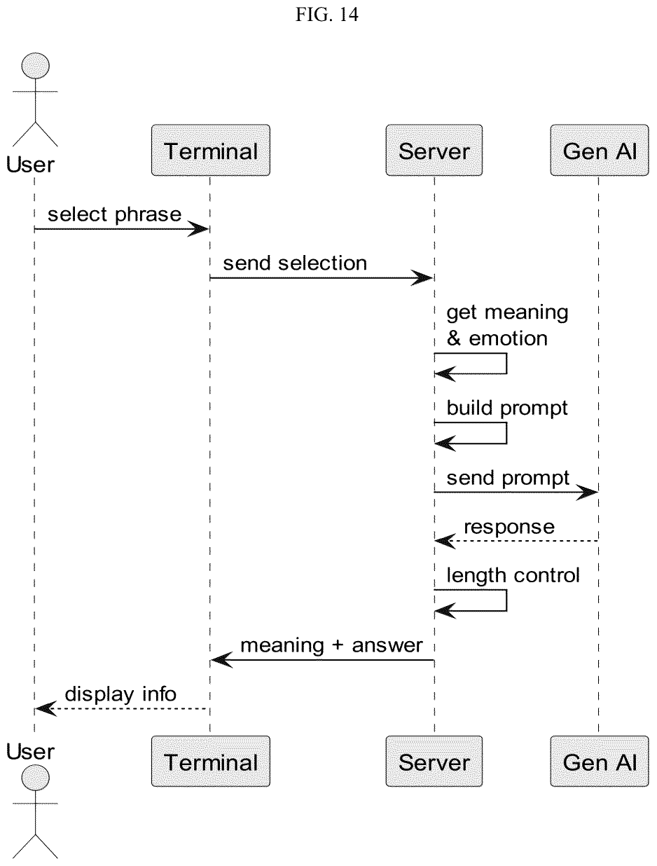

The following describes the processing flow using FIG. 14.

### Step 1:

User operates the terminal and selects a phrase on the display screen.
User performs a touch, long-press, drag, or click operation over a continuous region of text, such as a word or multi-word phrase, within an application screen (for example, a messaging screen or a transaction screen).
Input: Visually presented text on the display screen and user touch or pointer coordinates.
Output: A selected phrase and positional/context information recognized by the terminal.
Terminal uses the operating system's UI framework to map the coordinates of the user input to the underlying text buffer, extracts the corresponding substring as the selected phrase, and records metadata such as screen identifier, surrounding text, and time of selection.

### Step 2:

Terminal generates selection information and transmits it to the server.
Terminal constructs a data structure that includes the selected phrase, screen-type information, conversation or transaction identifiers, and one or more recent user utterances collected from the application.
Input: The selected phrase, screen identifier, recent messages, and user/session identifiers.
Output: A structured selection message sent over a communication network to the server.
Terminal serializes the data structure into a message format, attaches a protocol header, and transmits the message through a communication interface to a predefined server endpoint, then starts a pending state waiting for a response.

### Step 3:

Server receives the selection information and retrieves meaning information from a word storage resource.
Server parses the incoming message, validates the structure, and extracts the selected phrase and related context.
Input: The selection message containing the selected phrase and screen-type information.
Output: Meaning information including at least a base definition associated with the selected phrase.
Server executes a query operation against a word storage resource, such as a dictionary database, using the selected phrase as a key; the server performs string normalization if necessary (for example, lowercasing or removing diacritics), and then returns a matching entry that contains a definition and example usage.

### Step 4:

Server collects utterance information and computes emotion information using an emotion recognition model.
Server aggregates recent user utterances that are stored in the message or in a separate conversation log and passes these as input to an emotion classifier.
Input: One or more text utterances from the user, obtained from the selection message or from stored logs.
Output: Emotion information indicating an estimated emotional state of the user, such as sadness or excitement.
Server tokenizes the text, transforms each token into a numeric embedding, forwards the embedded sequence through a neural network architecture (such as a transformer with multiple self-attention layers), and computes a probability vector over predefined emotion classes; server selects the class with the highest probability as the emotion information and stores this value for subsequent processing.

### Step 5:

Server constructs a base prompt sentence using the selected phrase and screen-type information.
Server selects a prompt template corresponding to the type of screen (for example, messaging or transaction) and fills in placeholders with the selected phrase and a preliminary length limit.
Input: The selected phrase, screen-type information, and configuration parameters for character-length limits.
Output: A base prompt sentence string that instructs a generative AI model to produce an answer.
Server performs string concatenation and placeholder substitution to generate sentences like “What is QR code payment? Explain briefly within 200 characters.” or “What is blockchain? Explain it simply in less than 250 characters.” and stores this text as the base prompt.

### Step 6:

Server adjusts the base prompt sentence according to the emotion information.
Server reads the emotion information and modifies the tone instruction and length parameters of the base prompt to reflect the user's emotional state.
Input: The base prompt sentence and the emotion information computed in Step 4.
Output: An emotion-aware prompt sentence that includes both content and style constraints.
Server applies rule-based logic that maps each emotion class to specific textual modifiers (for example, “in a gentle and encouraging way” for sadness or “for a very tired user” for tiredness) and updates the prompt sentence, producing texts such as “The user is very tired. Explain the meaning of ‘empathy’in very simple language, within 120 characters.”

### Step 7:

Server embeds dictionary-based meaning information into the prompt sentence when available.
Server decides whether to include the retrieved meaning information and, if so, injects at least part of the definition into the prompt.
Input: The emotion-aware prompt sentence and the meaning information from the word storage resource.
Output: A final prompt sentence that constrains the generative AI model using both the dictionary definition and the emotional context.
Server concatenates the definition string and an instruction segment with the existing prompt, generating text such as “The dictionary definition of ‘empathy’ is: [definition]. Based on this, explain ‘empathy’ in friendly and simple language within 150 characters.” and stores the result as the final prompt sentence.

### Step 8:

Server transmits the final prompt sentence to a generative AI model and obtains a response sentence.
Server prepares a request for a remote or local generative AI model service, including the final prompt and generation parameters, and sends the request via a communication interface.
Input: The final prompt sentence, along with maximum token count and randomness parameters.
Output: A response sentence generated by the generative AI model.
Server converts the prompt text to model tokens using a tokenizer, specifies model parameters such as maximum token length and temperature, invokes the generative AI model, and receives back a sequence of tokens that form a response sentence, which is then converted back to a text string.

### Step 9:

Server applies a length control process to generate an adjusted response sentence.
Server evaluates the length of the response sentence against the character-length limitation information encoded in the prompt.
Input: The response sentence output by the generative AI model and the character-length limitation information.
Output: An adjusted response sentence that conforms to the length constraint.
Server counts characters or tokens, compares the count with the allowed limit, and, if the limit is exceeded, truncates the response at a natural boundary such as a space or sentence end; in some configurations, server sends the original response into a secondary summarization prompt and replaces the output with a shorter summary, then stores this processed text as the adjusted response sentence.

### Step 10:

Server assembles a response data structure and transmits it to the terminal.
Server combines the adjusted response sentence with meaning information and metadata such as the selected phrase and emotion information.
Input: Meaning information, the adjusted response sentence, and identifiers from the original selection message.
Output: A structured response message transmitted over the communication network to the terminal.
Server creates a record that includes fields for the base definition, adjusted explanation, and association tags, serializes the record into a message format, and sends the message to the terminal via the network interface.

### Step 11:

Terminal receives the response data and prepares display content.
Terminal parses the received message and extracts the meaning information and adjusted response sentence.
Input: The structured response message from the server.
Output: A formatted display representation ready to be rendered on the display screen.
Terminal merges the text segments into UI components, selects fonts and layout parameters according to screen-type and available space, and binds the explanation elements to the original selected phrase so that they can be shown in an appropriate region of the interface.

### Step 12:

Terminal displays the meaning information and the adjusted response sentence to the user.
Terminal updates the display screen to present the explanation in association with the selected phrase without requiring additional user navigation.
Input: The formatted display representation prepared in Step 11 and the current UI state.
Output: A visual rendering in which the base definition and the adjusted response sentence appear near or below the selected phrase.
Terminal draws an overlay, tooltip, or additional text block that contains the explanation, associates this visual element with the selected phrase location, and refreshes the screen; user then visually receives a concise, context-appropriate explanation controlled by the server and generated by the generative AI model based on the prompt sentence.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

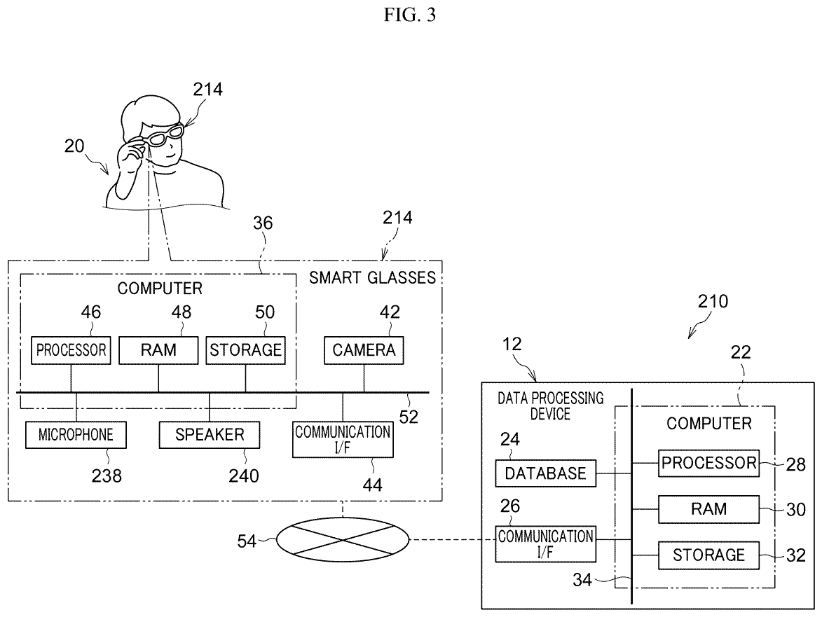

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

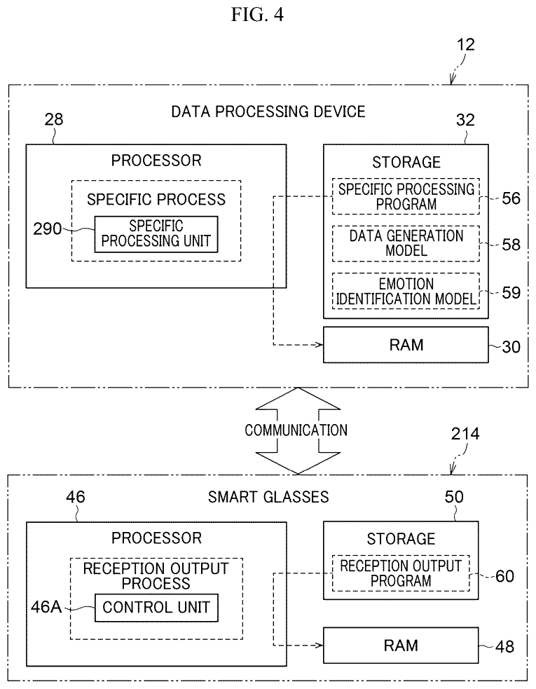

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

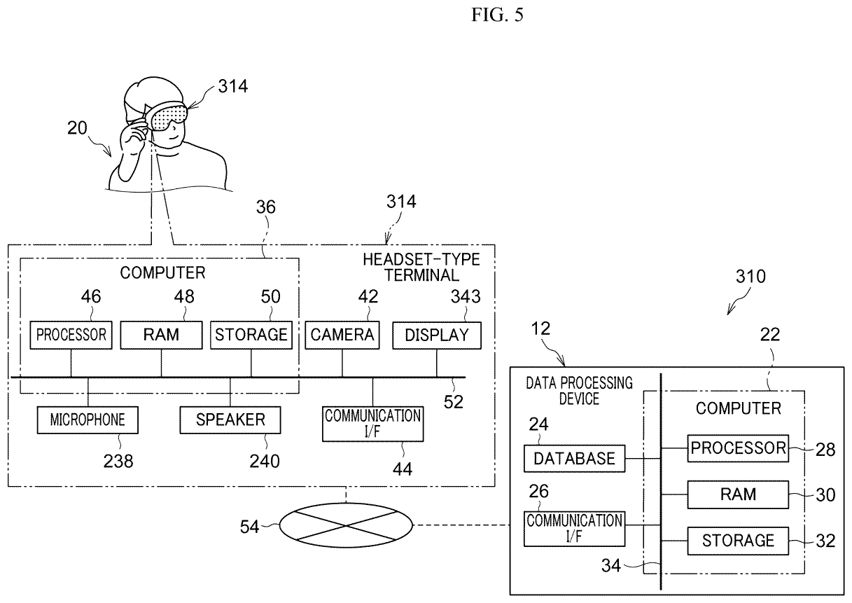

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

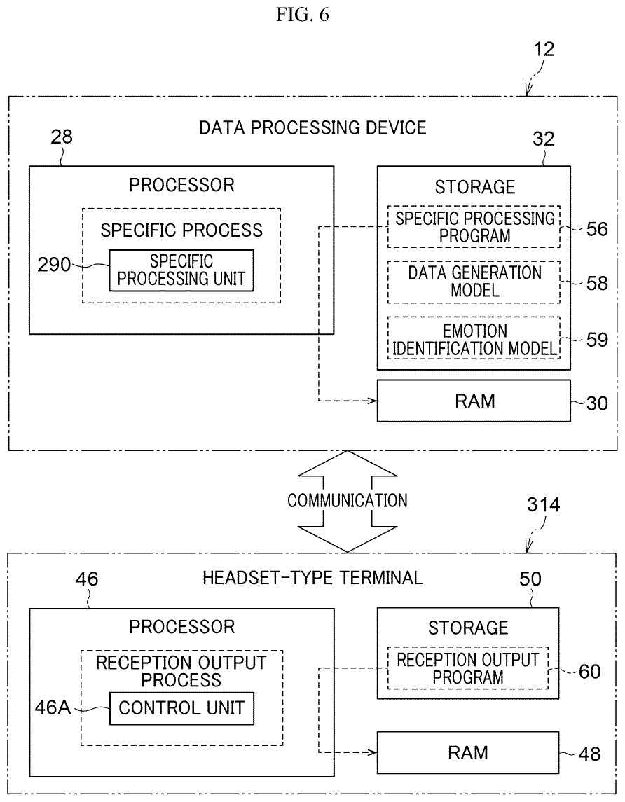

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

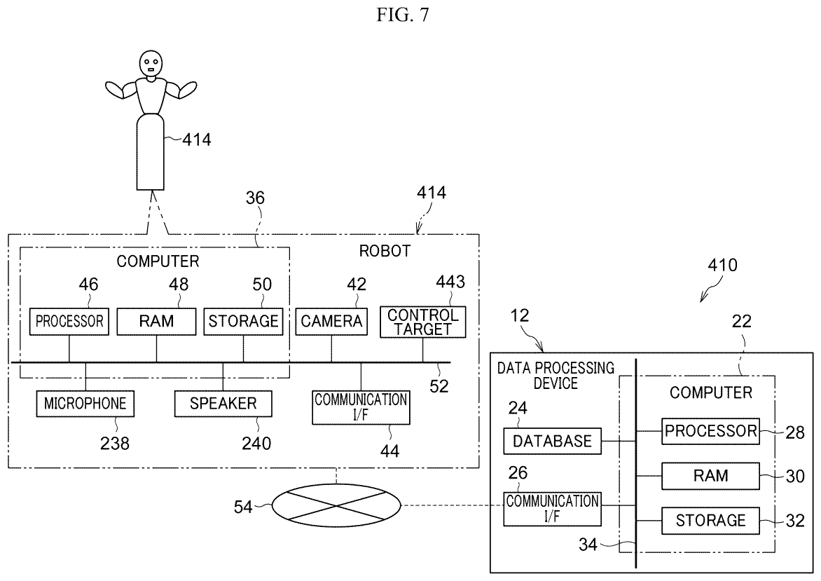

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

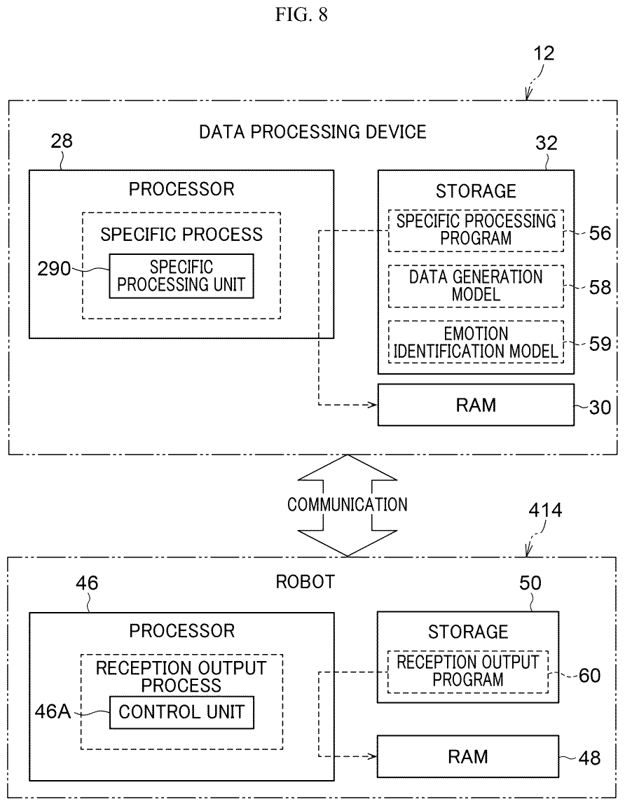

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### EXAMPLE 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### EXAMPLE 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

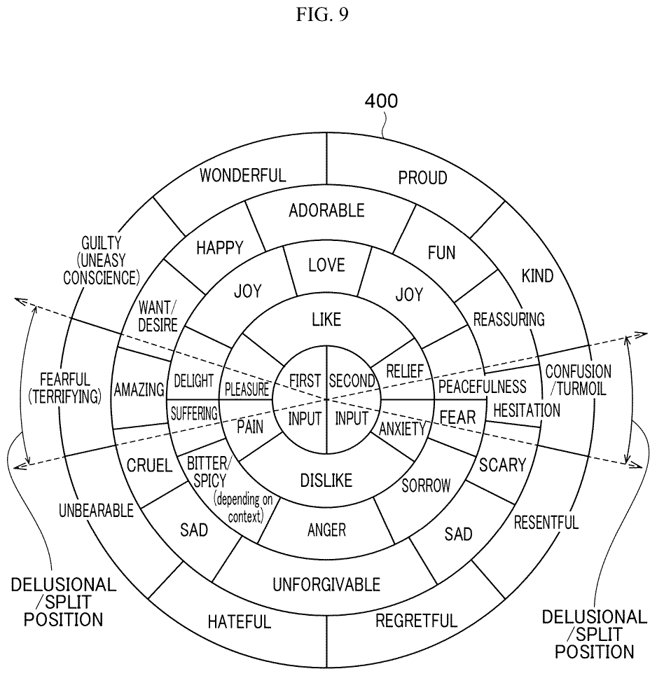

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

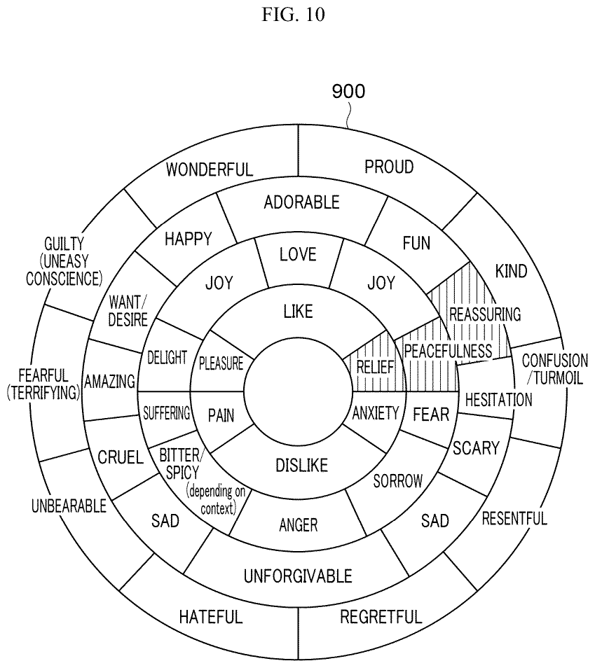

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### EXAMPLE 1

### Supplementary 1

A system comprising a processor,
wherein the processor is configured to
receive, from a terminal operating on a user information processing apparatus, inquiry data including character string data selected by a user on a display screen,
extract the selected character string data from the received inquiry data, query a dictionary storage device for meaning information corresponding to the character string data, acquire the meaning information, and transmit the acquired meaning information to the terminal so as to be displayed on the display screen,
generate, based on the selected character string data included in the received inquiry data, a prompt sentence for requesting an explanation of the character string data from a generative information processing apparatus implementing a generative AI model, and transmit the prompt sentence to the generative information processing apparatus,
receive, from the generative information processing apparatus, response text data that is automatically generated based on the prompt sentence,
execute, on the received response text data, a character count limiting process based on a preset upper limit of a number of characters so as to adjust a length of the response text data,
transmit the adjusted response text data to the terminal so as to be displayed, on the display screen, as a user interface element associated with the selected character string data,
assign a unique identification information to the inquiry data, store the unique identification information in association with the selected character string data and the response text data, and, when a display update request based on the unique identification information is received from the terminal, retransmit corresponding response text data to the terminal, and
accumulate, as statistical information, attribute information relating to the selected character string data, the prompt sentence, and the response text data, and automatically adjust at least one of the upper limit of the number of characters or a generation condition of the prompt sentence based on the statistical information.

### Supplementary 2

The system according to supplementary 1,
wherein the processor is configured to control the terminal such that the terminal: detects a character string selection operation on the display screen; generates the inquiry data including selected character string data, the unique identification information, and a display language type; transmits the inquiry data to the system; and arranges and displays, in a display region adjacent to the selected character string data on the display screen, the meaning information and the response text data received from the system as display elements in a chat format.

### Supplementary 3

The system according to supplementary 1,
wherein the processor is configured to cause the prompt sentence to include, in addition to the selected character string data, constraint information defining at least one of an upper limit of the number of characters of the response text data or a representation style of the response text data, and to cause the generative information processing apparatus implementing the generative AI model to generate the response text data in accordance with the constraint information.

### Application Example 1

### Supplementary 1

A system comprising a processor,
wherein the processor is configured to
receive, from a terminal functioning as an information presentation device worn by a user, phrase information including a phrase selected by the user via gaze input or contact input,
receive, via a communication network from the terminal, the phrase information, query a dictionary information storage unit based on the received phrase information to acquire meaning information, and transmit the meaning information to the terminal so that the meaning information is displayed in a display area of the information presentation device,
generate a prompt sentence for instructing a generative artificial intelligence model to generate a predetermined response, by selecting, based on context information indicating a usage situation in which the phrase is presented, one template from among a plurality of predetermined templates and inserting the selected phrase included in the phrase information into the selected template,
transmit the generated prompt sentence to the generative artificial intelligence model via the communication network and receive response information described in natural language from the generative artificial intelligence model,
determine a length of the received response information based on a preset character limit, and
when the character limit is exceeded, generate adjusted response information by either truncating the response information at a predetermined number of characters or generating an additional summarization prompt sentence and transmitting the summarization prompt sentence to the generative artificial intelligence model to acquire summarized response information, thereby applying the character limit to the response information, and
transmit the adjusted response information to the terminal so that the adjusted response information is superimposed and displayed in real time in the display area of the information presentation device for presentation to the user.

### Supplementary 2

The system according to supplementary 1,
wherein the processor is configured to
cause the terminal, when displaying the adjusted response information in the display area, to control line feed and character size based on a display resolution and a field of view of the information presentation device so as to superimpose and display the adjusted response information, and to cause the terminal to, in response to an additional phrase selection operation by the user, transmit a phrase included in the adjusted response information as new phrase information to the system.

### Supplementary 3

The system according to supplementary 1,
wherein the processor is configured to
store, in a storage unit, at least one of frequently used selected phrases and frequently used response information in association with each other, and, when phrase information identical or similar to previously received phrase information is received from the terminal, read corresponding response information from the storage unit and transmit the corresponding response information to the terminal prior to inquiring the generative artificial intelligence model, thereby shortening a response presentation time.

### EXAMPLE 2

### Supplementary 1

A system comprising a processor,
wherein the processor is configured to
detect, based on an operation of a user, a phrase selected on a display device, and acquire the selected phrase as character information,
generate, by performing character string processing on the acquired phrase, a prompt sentence including the phrase, and transmit the prompt sentence to a server device via a communication network,
receive, at the server device, the prompt sentence, call a generative AI model via an external information processing service by using the prompt sentence as input, and cause the generative AI model to generate response information,
receive, at the server device, the response information from the generative AI model, adjust the response information to display response information by performing character string processing based on a character count limit, and transmit the display response information to a terminal device of the user, and
cause, at the terminal device, the display response information to be displayed in a predetermined region of a display screen, and perform display control to present visual information indicating a processing progress status during processing from selection of the phrase to display of the display response information.

### Supplementary 2

The system according to supplementary 1,
wherein the processor is configured to perform, at the terminal device, preprocessing on the acquired phrase including deletion of blank characters and verification of a length of the phrase, and to generate the prompt sentence only when the phrase is determined to be valid.

### Supplementary 3

The system according to supplementary 1,
wherein the processor is configured to, at the server device, transmit constraint information relating to a length of a response together with the prompt sentence when calling the generative AI model, and, for the response information received from the generative AI model, determine a final length of the display response information based on both the constraint information and the character count limit.

### Application Example 2

### Supplementary 1

A system comprising a processor,
wherein the processor is configured to
acquire, from a terminal functioning as an information processing device, selection information indicating a phrase selected by a user on a display screen and screen-type information indicating a type of the display screen on which the phrase is selected,
transmit, to the terminal via a communication network, control information for causing the terminal to generate data including the selected phrase and the screen-type information, and
receive, from the terminal, the data including the selected phrase and the screen-type information,
refer to a word storage resource by using the selected phrase included in the data to obtain meaning information corresponding to the selected phrase,
analyze utterance information of the user received from the terminal and calculate emotion information indicating an emotional state of the user by using an emotion recognition model,
generate, on the basis of the selected phrase and the emotion information, a prompt sentence which instructs a generative artificial intelligence model to execute a predetermined response generation process and which includes character-length limitation information,
transmit the prompt sentence to the generative artificial intelligence model and obtain, from the generative artificial intelligence model, a response sentence generated in accordance with the prompt sentence,
perform, on the basis of the character-length limitation information, a length control process on the response sentence to generate an adjusted response sentence,
transmit the meaning information and the adjusted response sentence to the terminal, and
cause, by transmission of display control information to the terminal, the terminal to display the meaning information and the adjusted response sentence in association with the selected phrase on the display screen.

### Supplementary 2

The system according to supplementary 1,
wherein the processor is configured to
change at least one of tone and level of detail of an explanation indicated in the prompt sentence in accordance with the emotion information so as to control a tendency of the response generation by the generative artificial intelligence model.

### Supplementary 3

The system according to supplementary 1,
wherein the processor is configured to
embed at least part of the meaning information obtained from the word storage resource into the prompt sentence and instruct the generative artificial intelligence model, through the prompt sentence, to generate a supplementary explanation based on the meaning information.

What is claimed is:

1. A system comprising:
circuitry configured to
receive, via a communication interface coupled to a packet-switched network, inquiry data from a terminal device, the inquiry data comprising character string data selected on a display screen of the terminal device,
query a lexical data storage device for meaning information corresponding to the character string data, and transmit the meaning information to the terminal device for display on the display screen,
generate a prompt sentence for a generative neural network model based on the character string data, the prompt sentence including constraint information defining an upper limit of a number of characters for response text data,
transmit the prompt sentence to the generative neural network model and receive response text data generated by the generative neural network model,
execute a character count limiting process on the response text data based on the upper limit to generate adjusted response text data, and
transmit the adjusted response text data to the terminal device for display on the display screen as a user interface element associated with the character string data.

2. The system according to claim 1, wherein the circuitry is further configured to assign unique identification information to the inquiry data, and store the unique identification information in association with the character string data and the response text data in a storage device.

3. The system according to claim 2, wherein the circuitry is further configured to, when a display update request based on the unique identification information is received from the terminal device, retrieve corresponding response text data from the storage device and retransmit the corresponding response text data to the terminal device.

4. The system according to claim 3, wherein the circuitry is further configured to accumulate, as statistical information, attribute information relating to the character string data, the prompt sentence, and the response text data, and automatically adjust at least one of the upper limit or a generation condition of the prompt sentence based on the statistical information.

5. The system according to claim 4, wherein the attribute information comprises at least one of a character length of the character string data, a language type, a length of the response text data before and after the character count limiting process, and a truncation ratio.

6. The system according to claim 1, wherein the constraint information further defines a representation style for the response text data, and the prompt sentence instructs the generative neural network model to generate the response text data in accordance with both the upper limit and the representation style.

7. The system according to claim 1, wherein the character count limiting process comprises comparing a character count of the response text data against the upper limit, and when the character count exceeds the upper limit, truncating the response text data at a boundary that avoids splitting a multi-byte character.

8. The system according to claim 7, wherein the circuitry is further configured to, when the character count exceeds the upper limit, generate a summarization prompt sentence instructing the generative neural network model to produce a condensed version of the response text data within the upper limit, and transmit the summarization prompt sentence to the generative neural network model to acquire summarized response text data as the adjusted response text data.

9. The system according to claim 1, wherein the circuitry is further configured to select, based on context information indicating a usage situation in which the character string data is presented, one template from among a plurality of predetermined templates stored in a storage device, and insert the character string data into the selected template to generate the prompt sentence.

10. The system according to claim 9, wherein the context information comprises at least one of a screen type, a content domain, and a device type of the terminal device.

11. The system according to claim 1, wherein the circuitry is further configured to store, in a storage device, frequently used character string data and corresponding adjusted response text data, and when subsequently received character string data matches a stored entry, retrieve the corresponding adjusted response text data from the storage device and transmit the corresponding adjusted response text data to the terminal device without invoking the generative neural network model.

12. The system according to claim 1, wherein the circuitry is further configured to analyze utterance information received from the terminal device using an emotion recognition model to calculate emotion information indicating an emotional state, and to adjust at least one of tone and content of the prompt sentence based on the emotion information.

13. The system according to claim 12, wherein the emotion recognition model comprises a neural network configured to receive tokenized text data and output probability values for a plurality of emotion categories, and the circuitry selects an emotion category having a highest probability value as the emotion information.

14. The system according to claim 13, wherein the circuitry is further configured to, when the emotion information indicates a negative emotional state, modify the prompt sentence to include an instruction directing the generative neural network model to generate response text data using empathetic language within a reduced character limit.

15. The system according to claim 1, wherein the circuitry is further configured to embed at least part of the meaning information obtained from the lexical data storage device into the prompt sentence, and instruct the generative neural network model to generate a supplementary explanation based on the meaning information.

16. The system according to claim 1, wherein the circuitry is further configured to transmit visual information indicating a processing progress status to the terminal device during a period from receipt of the inquiry data to transmission of the adjusted response text data.

17. The system according to claim 1, wherein the terminal device comprises an information presentation device worn by a user, and the circuitry is further configured to control display of the adjusted response text data by adjusting line feed and character size based on a display resolution and a field of view of the information presentation device.

18. A system comprising:
circuitry configured to
receive, via a communication interface coupled to a packet-switched network, inquiry data from a terminal device, the inquiry data comprising character string data selected on a display screen and screen-type information,
query a lexical data storage device for meaning information corresponding to the character string data,
analyze utterance information received from the terminal device using an emotion recognition model to calculate emotion information,
select, based on the screen-type information, one template from among a plurality of predetermined templates, insert the character string data into the selected template, and adjust tone of the template based on the emotion information to generate a prompt sentence including character-length limitation information,
transmit the prompt sentence to a generative neural network model and receive response text data,
execute a character count limiting process on the response text data based on the character-length limitation information to generate adjusted response text data, and
transmit the meaning information and the adjusted response text data to the terminal device for display on the display screen in association with the character string data.

19. The system according to claim 18, wherein the circuitry is further configured to store frequently used character string data and corresponding adjusted response text data in a storage device, and when subsequently received character string data matches a stored entry, retrieve and transmit the corresponding adjusted response text data to the terminal device prior to invoking the generative neural network model.

20. A method comprising:
receiving, via a communication interface coupled to a packet-switched network, inquiry data from a terminal device, the inquiry data comprising character string data selected on a display screen of the terminal device,
querying a lexical data storage device for meaning information corresponding to the character string data, and transmitting the meaning information to the terminal device for display on the display screen,
generating a prompt sentence for a generative neural network model based on the character string data, the prompt sentence including constraint information defining an upper limit of a number of characters for response text data,
transmitting the prompt sentence to the generative neural network model and receiving response text data generated by the generative neural network model,
executing a character count limiting process on the response text data based on the upper limit to generate adjusted response text data, and
transmitting the adjusted response text data to the terminal device for display on the display screen as a user interface element associated with the character string data.
